(19) United States
(12) Patent Application Publication
(10) Pub. No.: US 2013/0244697 A1
(43) Pub. Date: Sep. 19, 2013

(54) POSITION MANAGEMENT SYSTEM, APPARATUS AND METHOD FOR DISTRIBUTING POSITION DATA

(71) Applicants: SHIN KUSAKARI, KANAGAWA (JP); SEIJI MIYAWAKI, KANAGAWA (JP); MICHITAKA FUKUDA, KANAGAWA (JP); KUNIHIRO MIYAUCHI, KANAGAWA (JP); SATOSHI KAWASAKI, KANAGAWA (JP); YASUO OHASHI, KANAGAWA (JP); SHINJI AOKI, KANAGAWA (JP); TAKAAKI HIROI, TOKYO (JP); YUSUKE MATSUSHITA, KANAGAWA (JP)

(72) Inventors: SHIN KUSAKARI, KANAGAWA (JP); SEIJI MIYAWAKI, KANAGAWA (JP); MICHITAKA FUKUDA, KANAGAWA (JP); KUNIHIRO MIYAUCHI, KANAGAWA (JP); SATOSHI KAWASAKI, KANAGAWA (JP); YASUO OHASHI, KANAGAWA (JP); SHINJI AOKI, KANAGAWA (JP); TAKAAKI HIROI, TOKYO (JP); YUSUKE MATSUSHITA, KANAGAWA (JP)

(73) Assignee: RICOH COMPANY, LTD.

(21) Appl. No.: 13/795,383

(22) Filed: Mar. 12, 2013

(30) Foreign Application Priority Data
Mar. 14, 2012 (JP) 2012-056958
Oct. 12, 2012 (JP) 2012-226948

(51) Int. Cl. H04W 4/04

(52) U.S. Cl. CPC H04W 4/04
USPC 455/456.2

(57) ABSTRACT

A distribution apparatus includes a distribution unit configured to distribute position data indicating a position of the distribution apparatus, a reception unit configured to receive data from a communication terminal that received the position data distributed by the distribution unit, the data received from the communication terminal including terminal identification data for identifying the communication terminal and the position data, and a transmission unit configured to transmit terminal setting data of the communication terminal. The reception unit is configured to receive the terminal setting data from a position data management system according to an inquiry transmitted from the communication terminal.

### BACKGROUND OF THE INVENTION

1. Field of the Invention

The present invention relates to a technology for distributing predetermined position data.

2. Description of the Related Art

Conventionally, the position of a communication terminal of a user is identified by using a GPS (Global Positioning System). With the GPS, wireless signals indicating time are transmitted from approximately 30 GPS satellites orbiting the earth. Then, a communication terminal located on earth uses its receiver to receive the wireless signals and calculates the difference between the time in which the wireless signals are transmitted from the GPS satellites and the time in which the wireless signals from the GPS satellites are received by the receiver of the communication terminal. The communication terminal performs the calculation with respect to at least 4 GPS satellites and identifies its position on earth based on the result of the calculation.

In recent years, size and power consumption of the receiver used for GPS communication are becoming smaller. For example, a GPS receiver is installed in a small battery-powered communication terminal such as a mobile phone.

However, with the GPS, it is difficult for the wireless signals of the GPS to reach a communication terminal located indoors. Therefore, another system is desired for indoor positioning. One example of such system is IMES (Indoor MEssaging System).

A distribution apparatus, which distributes wireless signals by using IMES, can distribute the wireless signals with the same electric waveform as the electric waveform of the wireless signals transmitted by GPS satellites. Therefore, the communication terminals that receive the wireless signals can use the same reception hardware (hardware used for reception) as the reception hardware used for GPS communication. Further, reception software (software used for reception) used for GPS communication can also be used by slightly modifying the reception software. Because position data indicating the position of the IMES distribution apparatus is distributed instead of time data (data indicating time), the communication terminal that receives the wireless signals simply needs to receive the position data and does not need to calculate time difference unlike outdoor positioning.

For example, Japanese Laid-Open Patent Publication No. 2011-145873 discloses a position management method using IMES. With this method, in a case where a communication terminal receives position data from an IMES distribution apparatus mounted to an indoor ceiling, a management server can manage the position of the communication terminal by transmitting the position data and a terminal ID of the communication terminal from the communication terminal to an access point in a wireless LAN according to an IEEE802.11x communication standard and transferring the position data and the terminal ID from the access point to the management server.

However, in order to transmit the position data and the terminal ID from the communication terminal according to a wireless LAN communication standard as described in Japanese Laid-Open Patent Publication No. 2011-145873, a wireless LAN transmitter is required for the communication terminal. Further, compared to a GPS receiver (whose power consumption is reduced in recent years) or an IMES receiver, a wireless LAN transmitter consumes a significantly large amount of power. Therefore, the communication terminal as a whole (including both the receiver and the transmitter) cannot take advantage of the reduction of power consumption of the GPS receiver because power consumption of the wireless LAN transmitter is not reduced even where power consumption of the GPS receiver is reduced.

Therefore, it is difficult to improve power reduction performance of the communication terminal.

### SUMMARY OF THE INVENTION

The present invention may provide a position management system, an apparatus and a method for distributing position data that substantially obviates one or more of the problems caused by the limitations and disadvantages of the related art.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by a position management system, an apparatus and a method for distributing position data particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a distribution apparatus including a distribution unit configured to distribute position data indicating a position of the distribution apparatus, a reception unit configured to receive data from a communication terminal that received the position data distributed by the distribution unit, the data received from the communication terminal including terminal identification data for identifying the communication terminal and the position data, and a transmission unit configured to transmit terminal setting data of the communication terminal, wherein the reception unit is configured to receive the terminal setting data from a position data management system according to an inquiry transmitted from the communication terminal.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating an overall configuration of a position management system according to an embodiment of the present invention;

FIG. 2 is a schematic diagram illustrating an external configuration of an electric device in a case where the electric device is an LED type fluorescent lighting apparatus according to an embodiment of the present invention;

FIG. 3 is a schematic diagram illustrating a state where a communication device is placed on a management object according to an embodiment of the present invention;

FIG. 4 is a schematic diagram illustrating a hardware configuration of a main body of an electric device in a case where the electric device is an LED type fluorescent lighting apparatus according to an embodiment of the present invention;

FIG. 5 is a hardware configuration of an LED lamp in a case where an electric device is an LED type fluorescent lighting apparatus according to an embodiment of the present invention;

FIG. 6 is a schematic diagram illustrating position data distributed by a distribution apparatus according to an embodiment of the present invention;

FIG. 7 is a schematic diagram illustrating a hardware configuration of a communication terminal according to an embodiment of the present invention;

FIG. 8 is a schematic diagram illustrating an example of a format of position data according to an embodiment of the present invention;

FIG. 9 is a schematic diagram illustrating a data structure of data including position data according to an embodiment of the present invention;

FIG. 10 is a schematic diagram illustrating a hardware configuration of a management object in a case where the management object is a mobile phone according to an embodiment of the present invention;

FIG. 11 is a schematic diagram illustrating a hardware configuration of a gateway according to an embodiment of the present invention;

FIG. 12 is a schematic diagram illustrating a hardware configuration of a position data management system according to an embodiment of the present invention;

FIG. 13 is a schematic diagram illustrating an example of management data managed by a position data management system according to an embodiment of the present invention;

FIG. 14 is a block diagram illustrating functions (function components) of a distribution apparatus and a communication terminal according to an embodiment of the present invention;

FIG. 15 is a block diagram illustrating functions (function components) of a management object in a case where the management object is a personal computer or a mobile phone according to an embodiment of the present invention;

FIG. 16 is a block diagram illustrating functions (function components) of a gateway and a position data management system according to an embodiment of the present invention;

FIG. 17 is a sequence diagram illustrating an operation of establishing a communication network in a ceiling according to an embodiment of the present invention;

FIG. 18 is a sequence diagram illustrating an operation of distributing position data according to an embodiment of the present invention;

FIG. 19 is a sequence diagram illustrating an operation of determining position data to be used by a communication terminal and determining a transmission destination of the position data according to an embodiment of the present invention;

FIG. 20 is a flowchart illustrating an operation that begins when position data is received by a communication terminal and ends when the position data is stored by the communication terminal according to an embodiment of the present invention;

FIG. 21 is a schematic diagram illustrating a state of communication between a distribution apparatus and a communication terminal according to an embodiment of the present invention;

FIG. 22 is a flowchart illustrating an operation of determining a transmission destination according to an embodiment of the present invention;

FIG. 23 is a sequence diagram illustrating mainly a process of managing position data according to an embodiment of the present invention;

FIG. 24 is a schematic diagram illustrating an example of a screen of a position data management system according to an embodiment of the present invention;

FIG. 25 is a schematic diagram illustrating another example of a screen of a position data management system according to an embodiment of the present invention;

FIG. 26 is a schematic diagram illustrating terminal setting data stored in a communication terminal according to an embodiment of the present invention;

FIG. 27 is a schematic diagram illustrating a communication data format of a terminal setting data that is transmitted from a position data management system after an inquiry is transmitted from a communication terminal to a position data management system via a distribution apparatus according to an embodiment of the present invention;

FIG. 28 is a schematic diagram illustrating management data (including terminal setting data) stored in a storage unit of a position data management system according to an embodiment of the present invention;

FIG. 29 is a block diagram illustrating functions (function components) of a distribution apparatus and a communication terminal according to another embodiment of the present invention;

FIG. 30 is a block diagram illustrating functions (function components) of a management object in a case where the management object is a personal computer or a mobile phone according to another embodiment of the present invention;

FIG. 31 is a block diagram illustrating functions (function components) of a gateway and a position data management system according to another embodiment of the present invention;

FIG. 32 is a flowchart of an operation of receiving position data based on terminal setting data and storing the received position data according to an embodiment of the present invention;

FIG. 33 is a flowchart illustrating an operation of a transmitting position data from a communication terminal based on terminal setting data according to an embodiment of the present invention;

FIG. 34 is a sequence diagram illustrating a process of inquiring for terminal setting data according to an embodiment of the present invention; and

FIG. 35 is a sequence diagram illustrating another process of inquiring for terminal setting data according to an embodiment of the present invention.

### DETAILED DESCRIPTION OF THE PREFERRED EMBODIMENTS

Next, embodiments of the present invention are described with reference to the accompanying drawings.

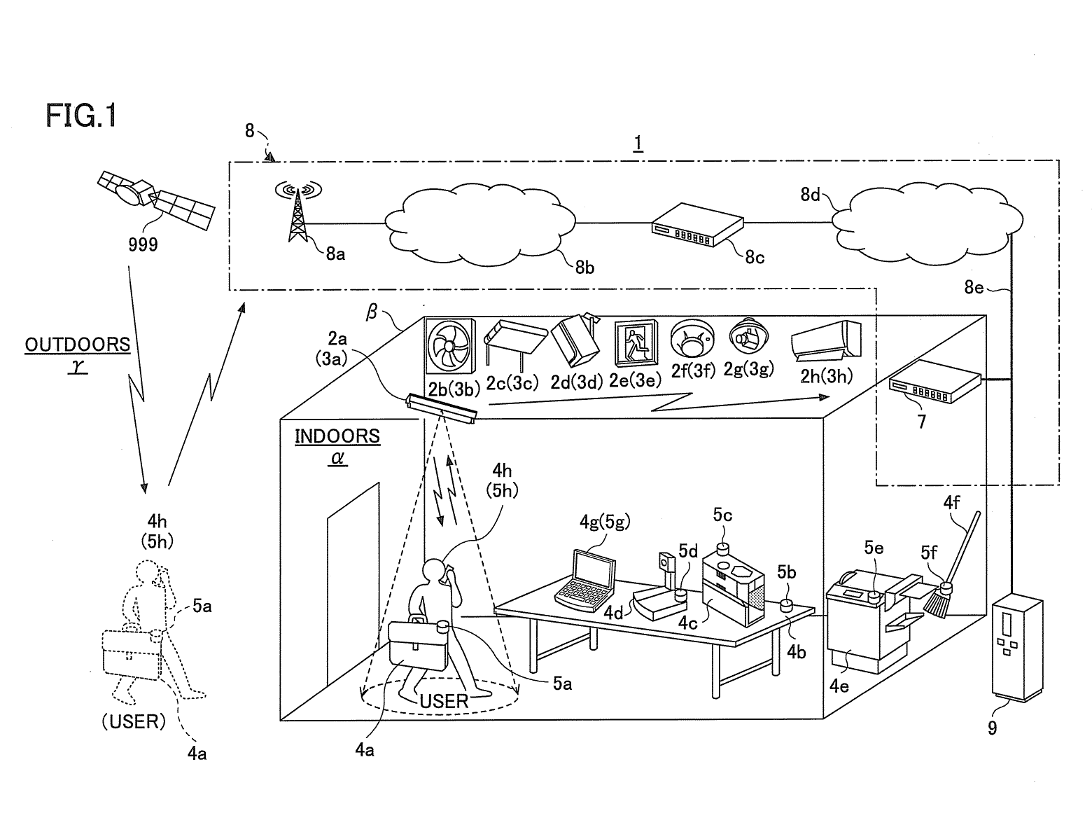

FIG. 1 is a schematic diagram illustrating an overall configuration of a position management system 1 according to an embodiment of the present invention.

As illustrated in FIG. 1, the position management system 1 according to an embodiment of the present invention includes, for example, multiple distribution apparatuses (3a, 3b, 3c, 3d, 3e, 3f, 3g, 3h) placed on a ceiling β in an indoor area α (also referred to as “indoors a”), multiple communication terminals (5a, 5b, 5c, 5d, 5e, 5f, 5g, 5h) placed on a floor in the indoor area α, and a position data management system 9.

Each of the distribution apparatuses (3a, 3b, 3c, 3d, 3e, 3f, 3g, 3h) stores position data (Xa, Xb, Xc, Xd, Xe, Xf, Xg, Xh) indicating a position in which each of the distribution apparatuses (3a, 3b, 3c, 3d, 3e, 3f, 3g, 3h) is to be placed. After the distribution apparatuses (3a, 3b, 3c, 3d, 3e, 3f, 3g, 3h) are placed to corresponding positions, the position data stored in each of the distribution apparatuses (3a, 3b, 3c, 3d, 3e, 3f, 3g, 3h) indicates the position in which each of the distribution apparatuses is being placed. Each of the distribution apparatuses (3a, 3b, 3c, 3d, 3e, 3f, 3g, 3h) distributes the stored position data (Xa, Xb, Xc, Xd, Xe, Xf, Xg, Xh) in a direction toward the floor of the indoor area α. Further, each of the distribution apparatuses (3a, 3b, 3c, 3d, 3e, 3f, 3g, 3h) stores apparatus identification data (Ba, Bb, Bc, Bd, Be, Bf, Bg, Bh) that identifies (distinguishes) each of the distribution apparatuses (3a, 3b, 3c, 3d, 3e, 3f, 3g, 3h).

A given distribution apparatus among the multiple distribution apparatus (3a, 3b, 3c, 3d, 3e, 3f, 3g, 3h) may be hereinafter indicated as “distribution apparatus 3”. A given communication terminal among the multiple communication terminals (5a, 5b, 5c, 5d, 5e, 5f, 5g, 5h) may be hereinafter indicated as “communication terminal 5”. Further, a given position data among the multiple position data (Xa, Xb, Xc, Xd, Xe, Xf, Xg, Xh) may be hereinafter indicated as “position data X”. A given apparatus identification data among the multiple apparatus identification data (Ba, Bb, Bc, Bd, Be, Bf, Bg, Bh) may be hereinafter referred to as “apparatus identification data B”. One example of the apparatus identification data B is a MAC (Media Access Control) address.

On the other hand, each of the communication terminals (5a, 5b, 5c, 5d, 5e, 5f, 5g, 5h) stores terminal identification data (Aa, Ab, Ac, Ad, Ae, Af, Ag, Ah) that identifies (distinguishes) each of the communication terminals (5a, 5b, 5c, 5d, 5e, 5f, 5g, 5h). A given terminal identification data among the terminal identification data (Aa, Ab, Ac, Ad, Ae, Af, Ag, Ah) may be hereinafter referred to as “terminal identification data A”. One example of the terminal identification data A is a MAC address. In a case where the communication terminal 5 receives position data X from the distribution apparatus 3, the communication terminal 5 transmits its own terminal identification data A (i.e. terminal identification data A of the communication terminal 5) and its own position data (position data X of the communication terminal 5) to the distribution apparatus 3.

Each distribution apparatus 3 is installed inside a corresponding electric device (2a, 2b, 2c, 2d, 2e, 2f, 2h) or externally mounted to the electric device (2a, 2b, 2c, 2d, 2e, 2f, 2h). The electric devices (2a, 2b, 2c, 2d, 2e, 2f, 2h) are placed to the ceiling β in the indoor area α. A given electric device among the electric devices (2a, 2b, 2c, 2d, 2e, 2f, 2h) may be hereinafter referred to as “electric device 2”.

Each electric device 2 supplies electric power to each distribution apparatus 3. Among the electric devices 2 according to the embodiment of FIG. 1, the electric device 2a is an LED (Light Emitting Diode) type fluorescent lighting apparatus; the electric device 2b is a ventilation fan; the electric device 2c is an access point of a wireless LAN (Local Area Network); the electric device 2d is a speaker; the electric device 2e is an emergency lamp; the electric device 2f is a fire alarm or a smoke detector; the electric device 2g is a security camera; and the electric device 2h is an air conditioner.

The electric devices 2 are not limited to those illustrated in FIG. 1 as long as the electric device 2 can feed electric power to the transmitting device 3. For example, other than the electric devices 2 illustrated in FIG. 1, the electric device 2 may also be a typical lighting apparatus such as a fluorescent lamp other than an LED type fluorescent lamp or an incandescent lamp, or a burglar alarm for detecting intrusion from the outside.

On the other hand, each communication terminal 5 is mounted to the outside of corresponding management objects (4a, 4b, 4c, 4d, 4e). The position of each of the management objects (4a, 4b, 4c, 4d, 4e) is managed by the position data management system 9.

Among the management objects (4a, 4b, 4c, 4d, 4e) according to the embodiment of FIG. 1, the management object 4a is a bag; the management object 4b is a table; the management object 4c is a projector; the management object 4d is a television conference terminal; the management object 4e is a MFP (Multi-Function Product) including, for example, a copying function; and the management object 4f is a broom.

Further, the management object 4g is a personal computer (PC). In a case where a function (s) of the communication terminal 5 is installed in the personal computer, the management object 4g is also a communication terminal 5g. The management object 4h is a mobile phone such as a smart phone. In a case where a function(s) of the communication terminal 5 is installed in the mobile phone, the management object 4h is also a communication terminal 5h. A given management object among the management objects (4a, 4b, 4c, 4d, 4e, 4f, 4g, 4h) may be hereinafter referred to as “management object 4”.

The management objects 4 are not limited to those illustrated in FIG. 1. For example, other than the management objects 4 illustrated in FIG. 1, the management object 4 may also be a facsimile machine, a scanner, a printer, a copier, an electronic blackboard, an air cleaner, a shredder, a vending machine, a wristwatch, a camera, an electronic game device, a wheelchair, or a medical device such as an endoscope.

Next, an example of a method for managing position data by using the position management system 1 is described.

In this embodiment, the distribution apparatus 3a, which is provided at the ceiling β in the indoor area α, uses wireless communication to transmit the position data Xa indicating the position at which the distribution apparatus 3a is placed (installed). Thereby, the communication terminal 5a receives the position data Xa distributed from the distribution apparatus 3a. Then, the communication terminal 5a, uses wireless communication to transmit terminal identification data (data for identifying (distinguishing) a terminal) Aa and position data Xa of the communication terminal 5a to the distribution apparatus 3a. In this case, the communication terminal 5a transmits (returns) the identification data Xa received from the distribution apparatus 3a back to the distribution apparatus 3a.

Thereby, the distribution apparatus 3a receives the terminal identification data Aa and the position data Xa from the communication terminal 5a. Then, the distribution apparatus 3a uses wireless communication to transmit the terminal identification data Aa and the position data Xa to the gateway 7. Then, the gateway 7 transmits the terminal identification data Aa and the position data Xa to the position data management system 9 via a LAN 8e. An administrator of the position data management system 9 can locate the position of the communication terminal 5a (management object 4a) in the indoor area α by managing the terminal identification data Aa and the position data Xa with the position data management system 9.

Further, as illustrated in FIG. 1, among the communication terminals, the communication terminals 5g, 5h, in particular, can particularly calculate the position on earth by receiving wireless signals (including, for example, time data, orbit data) in the outdoor area γ from a GPS satellite 999. Then, the communication terminals 5g, 5h can use a mobile communication system (e.g., 3G (3^{rd} Generation) system, 4G (4^{th} Generation) system) to transmit terminal identification data Ag, Ah and position data Xg, Xh to the position data management system 9 via a base station 8a, a mobile communication network 8b, a gateway 8c, the Internet 8D, and the LAN 8e, respectively.

It is to be noted that the communication network 8 according to an embodiment of the present invention is constituted by the base station 8a, the mobile communication network 8b, the gateway 8c, the Internet 8d, the LAN Be, and the gateway 7. Further, positioning (position measurement) of latitude and longitude on earth requires at least 3 GPS satellites (4 GPS satellites if altitude is also included), FIG. 1 illustrates one GPS satellite 999 for the sake of convenience.

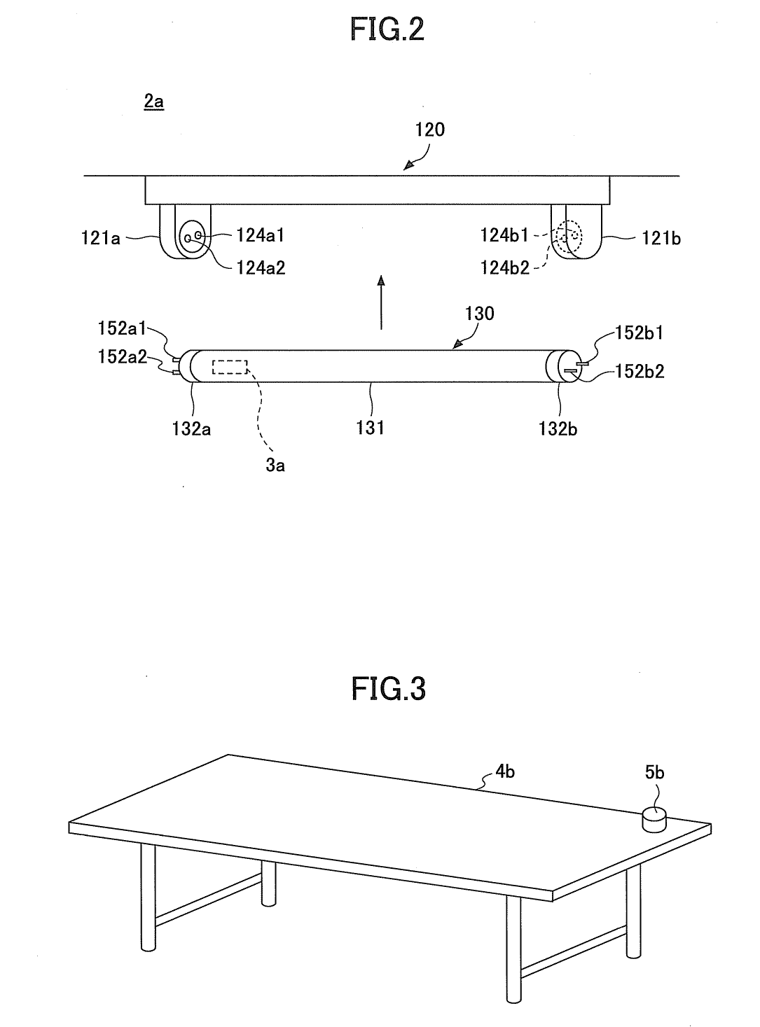

Next, an external configuration of the LED type fluorescent lighting apparatus 2a is described with reference to FIG. 2. The LED type fluorescent lighting apparatus 2a is one example of the electric device 2. FIG. 2 is a schematic diagram illustrating an external configuration of the electric device 2 in a case where the electric device 2 is an LED type fluorescent lighting apparatus 2a.

As illustrated in FIG. 2, the LED type fluorescent lighting apparatus (electric device) 2a is a straight tube type lamp. The LED type fluorescent lighting apparatus 2a includes a main body 120 that is attached to the ceiling β of the indoor area α of FIG. 1 and an LED lamp 130 that is attached to the main body 120.

Sockets 121a and 121b are provided on each end part of the main body 120. The socket 121a includes power feeding terminals 124a1, 124a2 for feeding power to the LED lamp 130. Further, the socket 121b includes power feeding terminals 124b1, 124b2 also for feeding power to the LED lamp 130. Thereby, the main body 120 can supply electric power from the below-described power source 1000 to the LED lamp 130.

The LED lamp 130 includes a translucent cover 131, caps 132a, 132b provided on each end part of the translucent cover 131, and the distribution apparatus 3a inside the translucent cover 131. The translucent cover 131 is formed of, for example, a resin material (e.g., acrylic resin). The translucent cover 131 is provided in a manner covering a light source inside the LED lamp 130.

Further, the cap 132a includes terminal pins 152a1, 152a2 that are connected to corresponding power feeding terminals 124a1, 124a2 of the socket 121a. The cap 132b includes terminal pins 152b1, 152b2 that are connected to corresponding power feeding terminals 124b1, 124b2 of the socket 121b. By mounting the LED lamp 130 to the main body 120, electric power can be supplied from the main body 120 to each of the terminal pins 152a1, 152a2, 152b1, 152b2 via corresponding power feeding terminals 124a1, 124a2, 124b1, 124b2. Thereby, the LED lamp 130 can radiate light to the outside by way of the translucent cover 131. The distribution apparatus 3a is operated by the electric power supplied from the main body 120.

Next, a status of the communication terminal 5 being placed on an upper surface of the management object 4 is described with reference to FIG. 3. In this embodiment, the management object 4 is a table 4b. FIG. 3 is a schematic diagram illustrating a state where the communication device 5 is placed on the management object 4 according to an embodiment of the present invention.

As illustrated in FIG. 3, the communication device 5b is mounted to the upper surface of the management object 4b. The communication device 5b may be mounted to the management object 4b by using, for example, a double-sided tape. Alternatively, the communication device 5b may simply be placed on the management object 4c.

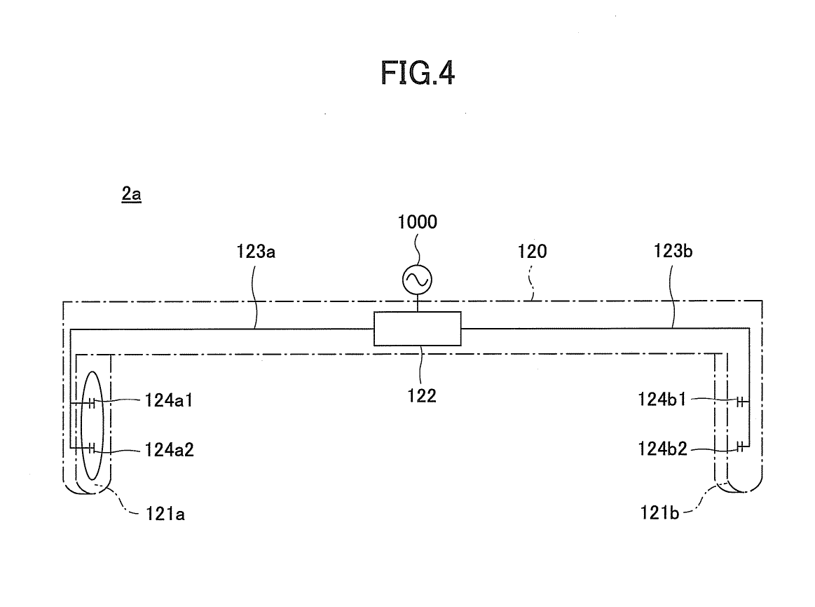

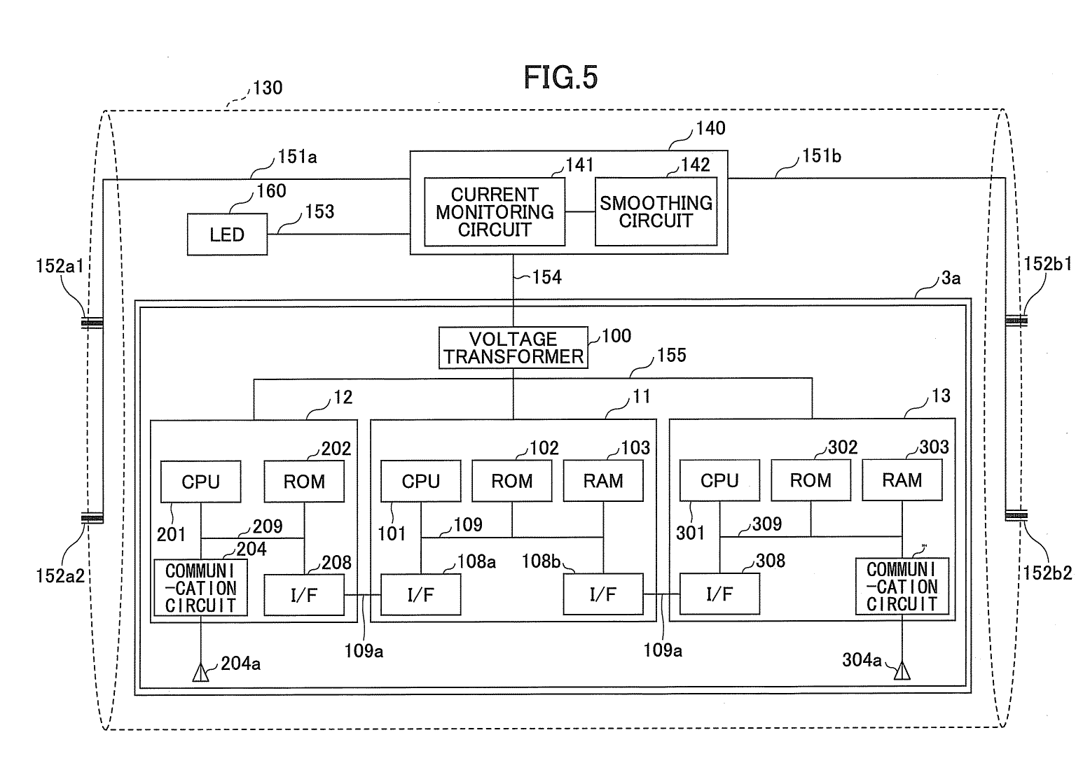

Next, with reference to FIGS. 4 and 5, a hardware configuration of the electric device 2 is described in a case where the electric device 2 is the LED type fluorescent lighting apparatus 2a. FIG. 4 is a schematic diagram illustrating a hardware configuration of a main body of the electric device 2 in a case where the electric device 2 is the LED type fluorescent lighting apparatus 2a. FIG. 5 is a hardware configuration of the LED lamp 130 in a case where the electric device 2 is the LED type fluorescent lighting apparatus 2a.

As illustrated in FIG. 4, the main body 120 mainly includes a ballast 122, lead wires 123a, 123b, and power feeding terminals 124a1, 124a2, 124b1, 124b2.

The ballast 122 controls the electric current supplied from an external power source 1000. The ballast 122 and the power feeding terminals 124a, 124a2, 124b1, 124b2 are electrically connected by the lead wires 123a, 123b. Thereby, electric power can be stably supplied from the ballast 122 to each of the power feeding terminals 124a, 124a2, 124b1, 124b2 via the lead wires 123a, 123b.

As illustrated in FIG. 5, the LED lamp 130 mainly includes a power control unit 140, lead wires 151a, 151b, terminal pins 152a1, 1522, 152b1, 152b2, lead wires 153, 154, 155, and the distribution apparatus 3a. The power control unit 140 controls the electric current supplied from the power source 1000. The power control unit 140 mainly includes a current monitoring circuit 141 and a smoothing circuit 142. The current monitoring circuit 141 rectifies the electric current input from the power source 1000. The smoothing circuit 142 smoothens the electric current rectified by the current monitoring circuit 141 and supplies power to each of the terminal pins 152a1, 1522, 152b1, 152b2 via the lead wires 151a, 151b.

The power control unit 140 and the terminal pins 152a1, 1522, 152b1, 152b2 are electrically connected by the lead wires 151a, 151b. The power control unit 140 and the distribution apparatus 3a are electrically connected by the lead wire 154. Although multiple LEDs 160 may be actually attached to the power control unit 140, FIG. 5 illustrates a single LED 160 attached to the power control unit for the sake of convenience. The configuration of LED lamp 130 is substantially the same as a common LED lamp except that the LED lamp 130 includes the distribution apparatus 3a.

Next, the distribution apparatus 3a according to an embodiment of the present invention is described. The distribution apparatus 3a includes a voltage transformer 100, a lead wire 155, a control unit 11, a position data distribution unit 12, and a wireless communication unit 13. The voltage transformer 100 is electrically connected to the control unit 11, the position data distribution unit 12, and the wireless communication unit 13 via the lead wire 155.

The voltage transformer 100 transforms the voltage supplied from the power control unit 140 to a driving voltage of the distribution apparatus 3a and supplies the transformed voltage to the control unit 11, the position data distribution unit 12, and the wireless communication unit 13.

The control unit 11 includes a CPU (Central Processing Unit) 101 for controlling overall operations of the control unit 11, a ROM (Read Only Memory) 102 for storing basic input/output programs therein, a RAM (Random Access Memory) 103 used as a work area of the CPU 101, an interface (I/F) 108a for transmitting/receiving signals with respect to the position data distribution unit 12, an interface 108b for transmitting/receiving signals with respect to the wireless communication unit 13, and a bus line (e.g., address bus, data bus) 109 for electrically connecting the units and elements included in the control unit 11.

The position data distribution unit 12 includes a CPU 201 for controlling overall operations of the position data distribution unit 12, a ROM 202 for storing basic input/output programs and the position data Xa therein, a communication circuit 204 and an antenna for distributing the position data Xa, the I/F 208 for transmitting/receiving signals with respect to the control unit 11, and a bus line (e.g., address bus, data bus) 209 for electrically connecting the units and elements included in the position data distribution unit 12.

The communication circuit 204 distributes the position data Xa by way of the antenna 204a by using IMES technology. As described above, IMES, which is also referred to as indoor GPS, is a technology used for indoor positioning. The range in which the position data X can reach (distribution range of position data X) is virtually illustrated with broken lines in FIG. 1. In a case where the height of the ceiling β of the indoor area a is approximately 3 meters, a transmission output is set to the IMES in the embodiment of FIG. 1, so that the radius of a virtual circle (illustrated with broken lines on the floor of the indoor area α) of the distribution range of the position data X is approximately 5 meters. However, by changing the settings of the transmission output of the IMES, the radius of the distribution range of the position data X can be set to be less than or greater than 5 meters.

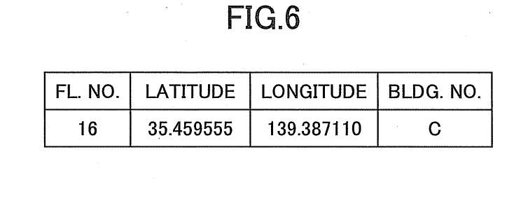

The position data Xa indicates a position in which the LED type fluorescent lighting apparatus (electric device) 2a is placed. As illustrated in FIG. 6, the position data Xa includes items such as floor number, latitude, longitude, and building number. FIG. 6 is a schematic diagram illustrating the position data Xa distributed by the distribution apparatus 3a.

The item “floor number” indicates the floor of the building in which the electric device 2a is placed. The item “latitude” indicates the latitude of the position in which the electric device 2a is placed. The item “longitude” indicates the longitude of the position in which the electric device 2a is placed. The item “building number” indicates the number of the building in which the electric device 2a is placed. In the example illustrated in FIG. 6, the electric device 2a indicates that the electric device is placed at a position having a north latitude of 35.459555 degrees and a east longitude of 139.387110 degrees on the 16^{th} floor of building C. Alternatively, latitude may be indicated by south latitude and longitude may be indicated by west longitude.

Returning to FIG. 5, the wireless communication unit 13 includes a CPU 301 for controlling overall operations of the wireless communication unit 13, a ROM 302 for storing basic input/output programs and the apparatus identification data Ba therein, a RAM 303 used as a work area of the CPU 301, a communication circuit 304 and an antenna 304a for receiving the position data Xa and the terminal identification data Aa and transmitting the received data to the gateway 17, an interface (I/F) 308 for transmitting/receiving signals with respect to the control unit 11, and a bus line (e.g., address bus, data bus) 309 for electrically connecting the units and elements included in the wireless communication unit 13.

The wireless communication unit 13 transmits/receives data by using a 920 MHz band. Because the 920 MHz band has high radio wave reachability, data can be transmitted from the distribution apparatus 3a to the gateway 7 even in a case where there is a column or wall of a building between the distribution apparatus 3a and the gateway 7.

The communication circuit 304 transmits/receives data by using at least the physical layer of an architecture model described in the IEEE802.15 standard. The communication circuit 304 performs the transmission/reception of data by using the antenna 304a. In this case where the physical layer of an architecture model described in the IEEE802.15 standard is used, a MAC address of the distribution apparatus 3 (wireless communication unit 13) may be used as the apparatus identification data B for identifying the distribution apparatus 3 (wireless communication unit 13).

Alternatively, the communication circuit 304 may transmit/receive data by using the physical layer of an architecture model described in the IEEE802.15 standard and a MAC layer of ZigBee (registered trademark). In this case where the physical layer the physical layer of an architecture model described in the IEEE802.15 standard and a MAC layer of ZigBee (registered trademark) are used, the distribution apparatus 3 transmits/receives data by using the 800 MHz band, the 900 MHz band, or the 2.4 GHz band in accordance to the region in which the band is used (e.g., Japan, U.S.A., Europe) with respect to the gateway 7 via another adjacent or neighboring distribution apparatus 3 (multi-hop communication). By using the multi-hop communication in which data is transmitted by way of other distribution apparatuses 3, it may take some time for the wireless communication unit 13 of each distribution apparatus 3 to perform a routing process. However, by using the multi-hop communication, the wireless communication unit 13 of each distribution apparatus 3 can perform communication with electric power that is enough to reach the nearest distribution data. Therefore, the multi-hop communication has an advantage of operating with a small amount of power.

The position data Xa may be stored in the below-described storage unit 29 of the distribution apparatus 3a before the distribution apparatus 3a is shipped from a factory of the manufacturer of the distribution apparatus 3a. Alternatively, the position data Xa may be stored in the storage unit 29 after the distribution apparatus 3a is shipped from the factory. For example, in a case of mounting the electric device 2a to the ceiling β, the position data Xa may be stored in the storage unit 29 by the person mounting the electric device 2a to the ceiling β. Alternatively, the position data Xa transmitted from an external device (e.g., position data management system 9) by wireless communication via the gateway 7 and receives by the communication circuit 304 of the wireless communication unit 13. Thereby, the position data Xa can be stored in the ROM 202 of the position data distribution unit 12 by the control unit 11.

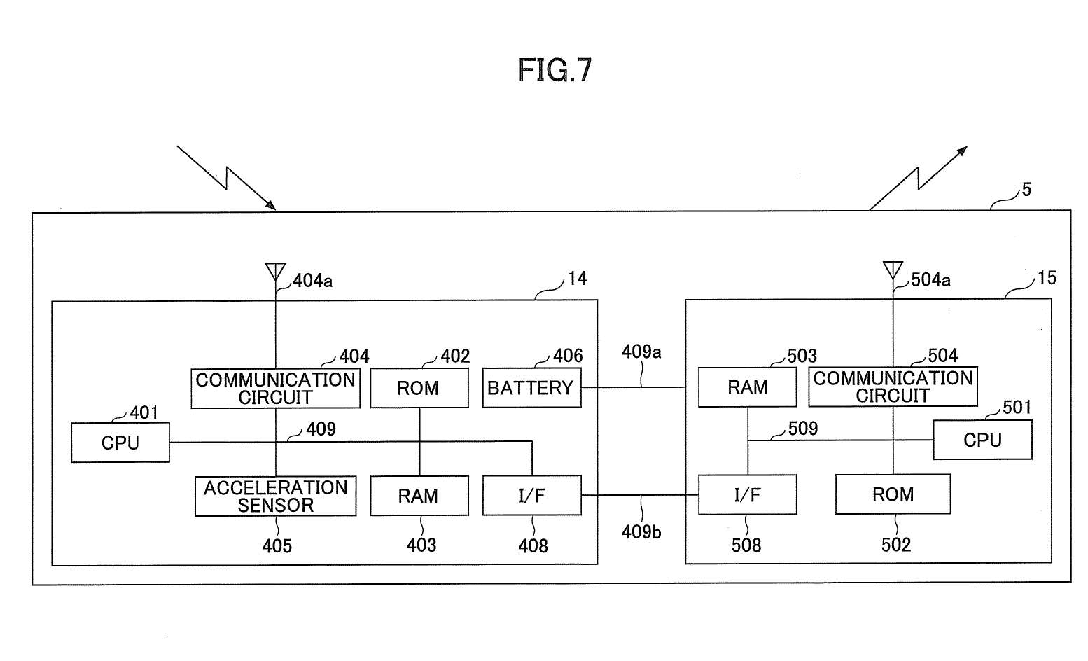

Next, a hardware configuration of the communication terminal 5 is described with reference to FIG. 7. FIG. 7 is a schematic diagram illustrating the hardware configuration of the communication terminal 5 according to an embodiment of the present invention.

As illustrated in FIG. 7, the communication terminal 5 includes a control unit 14 and a wireless communication unit 15.

The control unit 14 includes a CPU 401 for controlling overall operations of the control unit 14, a ROM 402 for storing basic input/output programs therein, a RAM 403 used as a work area of the CPU 401, a communication circuit 404 and an antenna 404a for receiving the position data Xa, an acceleration sensor 405 for detecting acceleration of the communication terminal 5, an interface (I/F) 408 for transmitting/receiving signals with respect to the wireless communication unit 15, and a bus line (e.g., address bus, data bus) 409 for electrically connecting the units and elements included in the control unit 14. The control unit 14 also includes a button battery 406 for driving the communication terminal 5. Not only can the communication terminal 5 be driven by the button battery, but may be driven by a common battery (e.g., double A battery, triple A battery) or a battery dedicated to the communication terminal 5.

The communication circuit 404 receives the position data X being distributed by using IMES. The communication circuit 404 receives the distributed position data X with the antenna 404a. The control unit 14 supplies the electric power of the button battery 406 to the wireless communication unit 15 via a connector 409a. The control unit 14 transmits/receives data (signals) with respect to the wireless communication unit 15 by way of the I/F 408 and the connector 409b.

The acceleration sensor 405 detects changes of the acceleration of the communication terminal 5. Changes of the acceleration of the communication terminal 5 may be detected, for example, when the communication terminal 5 starts moving, when the moving of the communication terminal 5 stops, or when the communication terminal 5 is tilted (inclined). In a case where change of acceleration is detected when the CPU 401 is not operating (stopped), the acceleration sensor 405 transmits a signal to the CPU 401 for causing the CPU 401 to start operation. Thereby, the CPU 401 begins to operate and also transmits a signal to the communication circuit 404 for causing the communication circuit 404 to start operation. Thereby, in a case where the position data X is being distributed by the distribution apparatus 3, the communication circuit 404 of the communication terminal 5 can start receiving the position data X via the antenna 404a.

On the other hand, the wireless communication unit 15 basically has the same configuration as the above-described configuration of the wireless communication unit 13. Thus, the wireless communication unit 15 can transmit/receive data with respect to the wireless communication unit 13 of the distribution apparatus 3 by using the same band used by the wireless communication unit 13. As illustrated in FIG. 7, the wireless communication unit 15 includes a CPU 501 for controlling overall operations of the wireless communication unit 15, a ROM 502 for storing basic input/output programs and the terminal identification data A therein, a RAM 503 used as a work area of the CPU 501, a communication circuit 504 and an antenna 504a for transmitting the position data X or the terminal identification data A, an interface (I/F) 508 for transmitting/receiving signals with respect to the control unit 14, and a bus line (e.g., address bus, data bus) 509 for electrically connecting the units and elements included in the wireless communication unit 15. Alternatively, the wireless communication unit 15 may also use ZigBee (registered trademark).

The communication circuit 504 obtains the position data X stored in the RAM 403 of the control unit 14 by way of the connector 409b according to an instruction(s) from the CPU 501. Further, the communication circuit 504 reads out the terminal identification data A stored in the ROM 502 and transmits the terminal identification data A together with the obtained position data X to the distribution apparatus 3 via the antenna 504a.

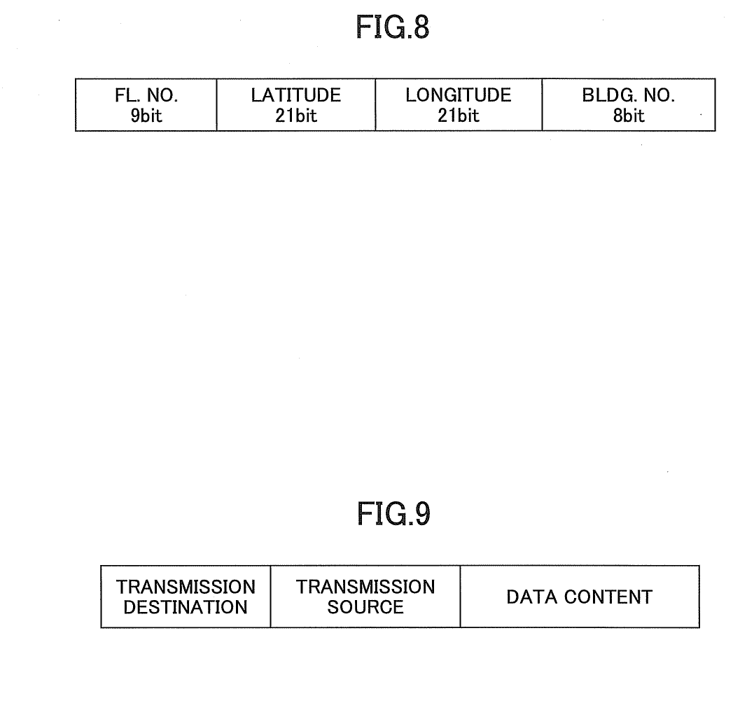

The configuration of the position data X transmitted by the communication circuit 504 may have a format as illustrated in FIG. 8. FIG. 8 is a schematic diagram illustrating an example of a format of the position data X according to an embodiment of the present invention. In the example illustrated in FIG. 8, the fields “floor number”, “latitude”, “longitude”, and “building number” are represented with 9 bits, 21 bits, 21 bits, and 8 bits, respectively. The format of each of the fields complies with the IMES standard. The actual format of the position data X is also added with a header defined according to the communication system, and checksum data. As illustrated in FIG. 9, the data structure of the data to be transmitted by the communication circuit 504 may include “transmission destination”, “transmission source”, and “data content (e.g., position data X). FIG. 9 is a schematic diagram illustrating a data structure of data including position data X according to an embodiment of the present invention.

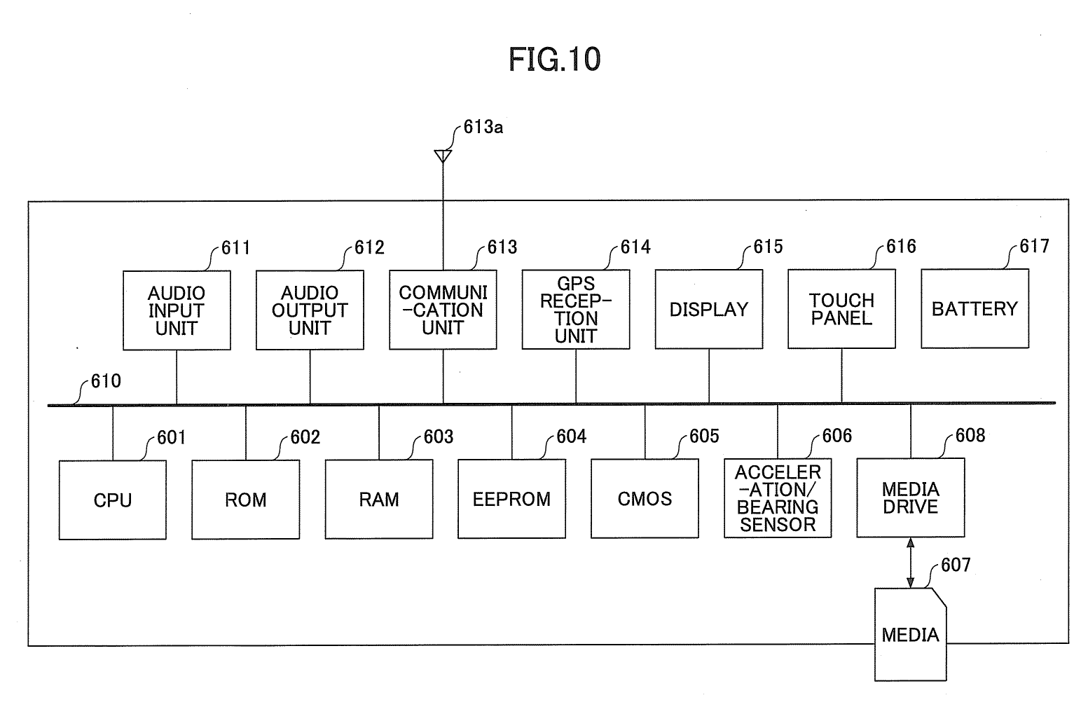

Next, a hardware configuration of the management object 4h is described with reference to FIG. 10. In this embodiment, the management object 4h (communication terminal 5h) is a mobile phone.

As illustrated in FIG. 10, the management object 4h (communication terminal 5h) includes a CPU 601 for controlling overall operations of the communication terminal 5h, a ROM 602 for storing basic input/output programs therein, a RAM 603 used as a work area of the CPU 601, a EEEPROM (Electrically Erasable and Programmable ROM) 604 for reading/writing data according to the controls of the CPU 601, a CMOS (Complementary Metal Oxide Semiconductor) sensor 605 for imaging (capturing) an object and obtaining image data of the object according to the controls of the CPU 601, one or a variety of acceleration/bearing sensors (e.g., electromagnetic compass for detecting earth magnetism, a gyrocompass, an acceleration sensor) 606, and a media drive 608 for controlling reading/writing (recording) of data with respect to a recording medium or media (e.g., flash memory) 607. The recording medium 607 is configured to detach/attach with the management object 4h (communication terminal 5h) for having recorded data read therefrom or new data recorded (written) thereto in accordance with the controls of the media drive 608.

An operating system (OS), various program, and various data that are executed by the CPU 601 are stored in the EEPROM 604. The CMOS sensor 605 is a charged coupled device (CCD) that captures light of an image of an object and converts the image into electron charges. As long as an image can be captured, the CMOS sensor 605 may be a sensor other than the CCD sensor.

The management object 4h (communication terminal 5h) may also include an audio input unit 11 for converting audio into audio signals, an audio output unit 612 for converting audio signals into audio, an antenna 613a, a communication unit 613 for performing communications (transmission/reception) with a nearest base station 8a by using wireless communication signals via the antenna 613a, a GPS reception unit 614 for receiving GPS signals from the GPS satellite 999, a display (e.g., liquid crystal display, organic electroluminescence (EL) display) 615 for displaying, for example, an image of an object or various icons, a touch panel 616 including a pressure-sensitive type or an electrostatic type display panel for detecting a position in the display panel touched with a finger or a stylus, and a bus line (e.g., address bus, data bus) 610 for electrically connecting the units and elements included in the management object 4h (communication terminal 5h). Further, a battery dedicated for the management object 4h (communication terminal 5h) is provided in the management object 4h (communication terminal 5h) for driving the management object 4h (communication terminal 5h). The audio input unit 611 includes a microphone for inputting audio. The audio output unit 612 includes a speaker for outputting audio.

The GPS reception unit 614 of the management object 4h (communication terminal 5h) has substantially the same configuration as a GPS reception unit of a typical mobile phone. However, the firmware of the program stored in the ROM 602 may be slightly adjusted (modified) for achieving seamless data reception from the distribution apparatus 3 of the indoor area α and the GPS satellite 999 of the outdoor area γ. The acceleration/bearing sensor 606 serves to provide the processes of the acceleration sensor 605 of FIG. 7.

Because the hardware configuration of the management object 4g (communication terminal 5g), which is a personal computer, has substantially the same configuration as the hardware configuration of the position data management system 9 of FIG. 9, further explanation of the hardware configuration of the management object 4g (communication terminal 5g) is omitted. However, in a case where the management object 4g (communication terminal 5g) is a personal computer, an external device I/F (e.g., USB (Universal Serial Bus) (similar to the external device I/F) is connected to a GPS antenna. However, in a case of a personal computer equipped with a GPS antenna, there is no need for connecting the external device I/F to the GPS antenna.

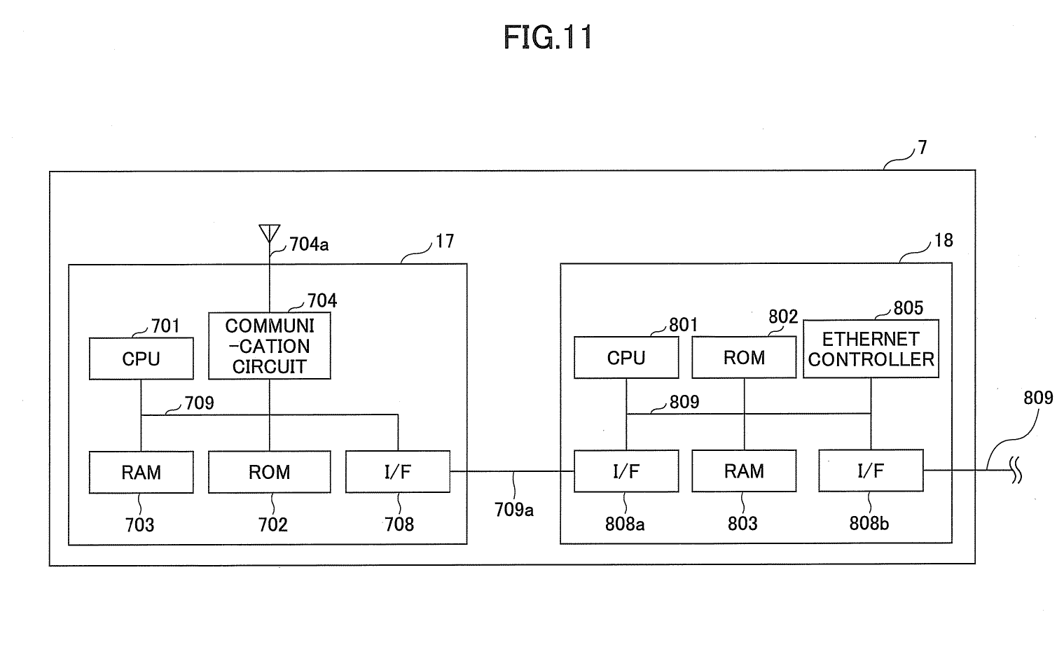

Next, a hardware configuration of the gateway 7 according to an embodiment of the present invention is described with reference to FIG. 11. FIG. 11 is a schematic diagram illustrating the hardware configuration of the gateway 7 according to an embodiment of the present invention.

As illustrated in FIG. 11, the gateway 7 includes a wireless communication unit 17 and a wired communication unit 18. As described below, regardless of whether position data X distributed from the same distribution apparatus 3 is received numerous times within a predetermined period, the received position data is handled as a single position data X.

The wireless communication unit 17 basically has the same configuration as the above-described configuration of the wireless communication unit 13. Thus, the wireless communication unit 17 can transmit/receive data with respect to the wireless communication unit 13 of the distribution apparatus 3 by using the same band used by the wireless communication unit 13. As illustrated in FIG. 11, the wireless communication unit 17 includes a CPU 701 for controlling overall operations of the wireless communication unit 17, a ROM 702 for storing basic input/output programs and the apparatus identification data C therein, a RAM 703 used as a work area of the CPU 701, a communication circuit 704 and an antenna 704a for transmitting data such as the position data X, an interface (I/F) 708 for transmitting/receiving signals with respect to the wired communication unit 18, and a bus line (e.g., address bus, data bus) 709 for electrically connecting the units and elements included in the wireless communication unit 17.

Alternatively, the wireless communication unit 17 may also use ZigBee (registered trademark). The apparatus identification data C is data that is unique to the gateway 7 (communication unit 17) for identifying the gateway 7 (communication unit 17). The apparatus identification data C may be, for example, a MAC address.

On the other hand, as illustrated in FIG. 11, the wired communication unit 18 includes a CPU 801 for controlling overall operations of the wired communication unit 18, a ROM 802 for storing basic input/output programs and the apparatus identification data D therein, a RAM 803 used as a work area of the CPU 801, an Ethernet controller 805, an interface (I/F) 808a for transmitting/receiving signals with respect to the wireless communication unit 17, an interface (I/F) for transmitting/receiving signals with respect to the LAN 8e via a cable 809, and a bus line (e.g., address bus, data bus) 809 for electrically connecting the units and elements included in the wired communication unit 18.

The CPU 801 and the Ethernet controller 805 perform controls for converting a communication method (communication protocol) conforming to IEEE802.15.4 to a communication method (communication protocol) conforming to IEEE802.3 and performing Ethernet packet communications to transmit/receive various data distributed from the distribution apparatus 3.

The apparatus identification data D is data that is unique to the gateway 7 (communication unit 18) for identifying the gateway 7 (communication unit 18). The apparatus identification data D may be, for example, an IP (Internet Protocol) address. Although a MAC address is stored in the ROM 802, description of the MAC address is omitted for simplifying the description of the communication with respect to the position data management system 9.

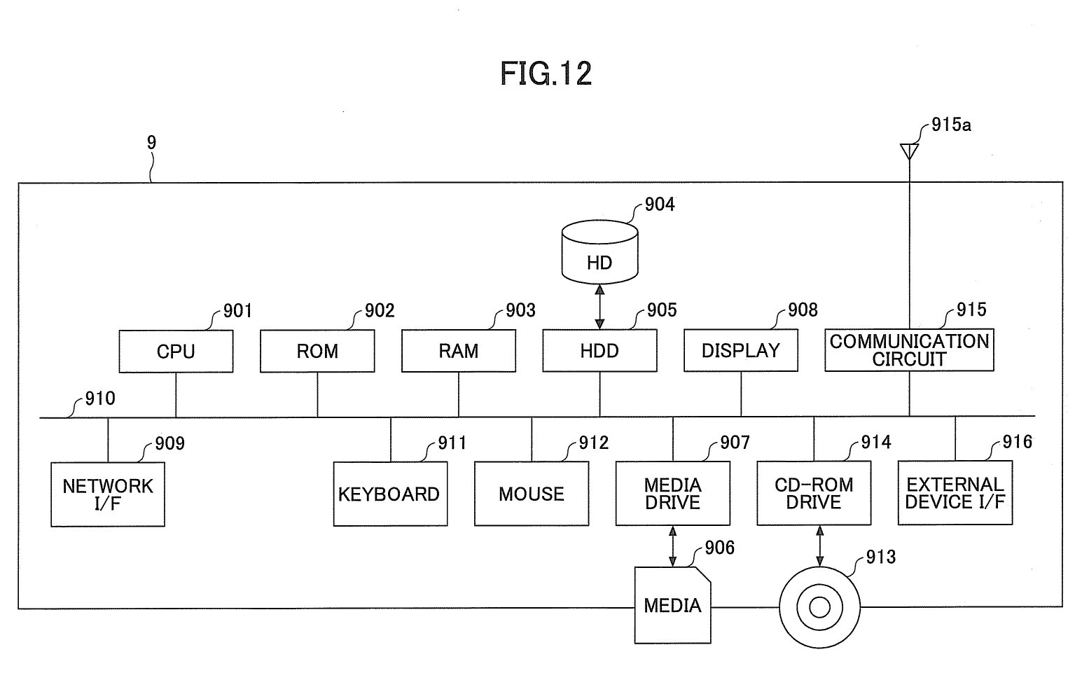

Next, a hardware configuration of the position data management system 9 according to an embodiment of the present invention is described with reference to FIG. 12. FIG. 12 is a schematic diagram illustrating the hardware configuration of the position data management system 9 according to an embodiment of the present invention.

The position data management system 9 is constituted by a computer. For example, the position data management system 9 includes a CPU 901 for controlling overall operations of the position data management system 9, a ROM 902 for storing a program (e.g., IPL (Initial Program Loader)) used for driving the CPU 901 therein, a RAM 903 used as a work area of the CPU 901, a HD (Hard Disk) 904 for storing various data such as programs for the position data management system 9 or system identification data E therein, a HDD (Hard Disk Drive) for controlling reading/writing (recording) data with respect to the HD 904 according to the controls of the CPU 901, a media drive 907 for controlling reading/writing (recording) of data with respect to a recording medium or media (e.g., flash memory) 906, a display 908 for displaying various data (e.g., cursors, menus, windows, characters, images), a network interface (I/F) 909 for performing data communications (transmission/reception) by way of a communication network 8, a keyboard 911 including multiple keys for inputting various data such as characters, numerals, and instructions, a mouse 912 for performing, for example, selection and execution of various instructions, selection of a process object, and moving of a cursor, a CD-ROM (Compact Disc Read Only Memory) driver 914 for controlling reading/writing (recording) of data with respect to a detachable recording medium (e.g., CD-ROM), a communication circuit 915 and an antenna 915a for performing wireless communication, an external device I/F 916 for connecting to an external device, and a bus line (e.g., address bus, data bus) 910 for electrically connecting the units and elements included in the position data management system 9.

The system identification data E is data that is unique to the position data management system 9 for identifying the position data management system 9. The system identification data E may be, for example, an IP address. Although a MAC address is stored in the ROM 902, description of the MAC address is omitted for simplifying the description of the communication with respect to the gateway 7.

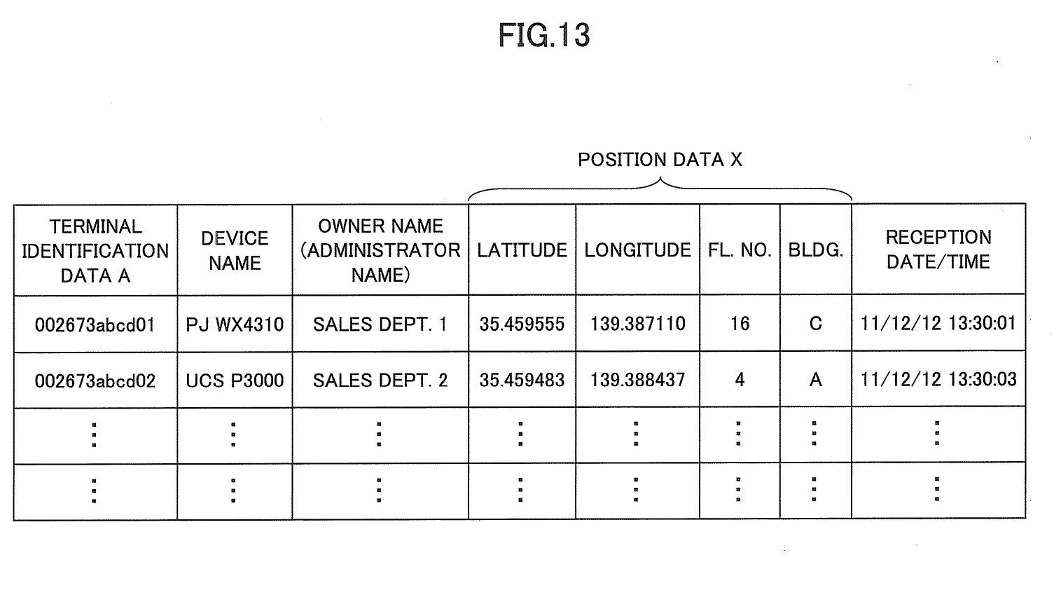

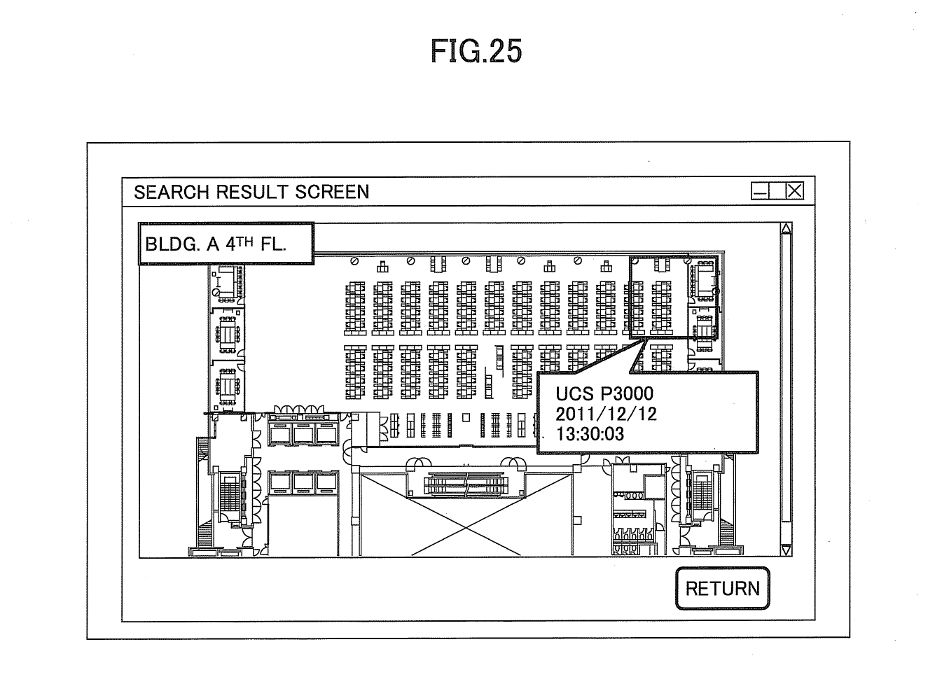

Management data F (see FIG. 13) and layout data G are stored in the HD 904. FIG. 13 is a schematic diagram illustrating an example of the management data F managed by the position data management system 9 according to an embodiment of the present invention. As described below, the layout data includes data pertaining to, for example, a particular floor as illustrated in FIG. 25.

As illustrated in FIG. 13, the management data F has terminal identification data A, device name data, owner name data (administrator name data), position data X, and reception time/date data that are associated to each other.

As described above, the terminal identification data A is for identifying the communication terminal 5. The device name data is data indicating the name of the management object 4 or the name of the communication terminal 5. The owner name data (administrator name data) is data indicating the name of the owner or the administrator of the communication terminal 5. The position data X is the above-described data illustrated in FIG. 6. The reception time/date data is data indicating the time and date in which data such as position data X from the gateway 7 is received by the position data management system 9.

The terminal identification data A, the device name data, and the owner name data (administrator name data) are associated to each other beforehand and managed by the position data management system 9. In a case where the position data management system 9 receives the position data X and the terminal identification data A from the gateway 7, the position data management system 9 adds the received position data X and the terminal identification data A to a record portion of the management data F that includes the same terminal identification data A as the received terminal identification data A.

Further, in a case of newly receiving position data X and the terminal identification data A from the gateway 7 in a state where a corresponding position data X and its reception time/date data are already being managed by the position data management system 9, the position data management system 9 overwrites the managed position data and the reception time/date data with the newly received position data and its new reception time/date data.

Alternatively, in a case of newly receiving position data X and the terminal identification data A from the gateway 7 in a state where a corresponding position data X and its reception time/date data are already being managed by the position data management system 9, the position data management system 9 may generate a new record and record (write) the newly received position data and its new reception time/date data instead of overwriting the managed position data and reception time/date data.

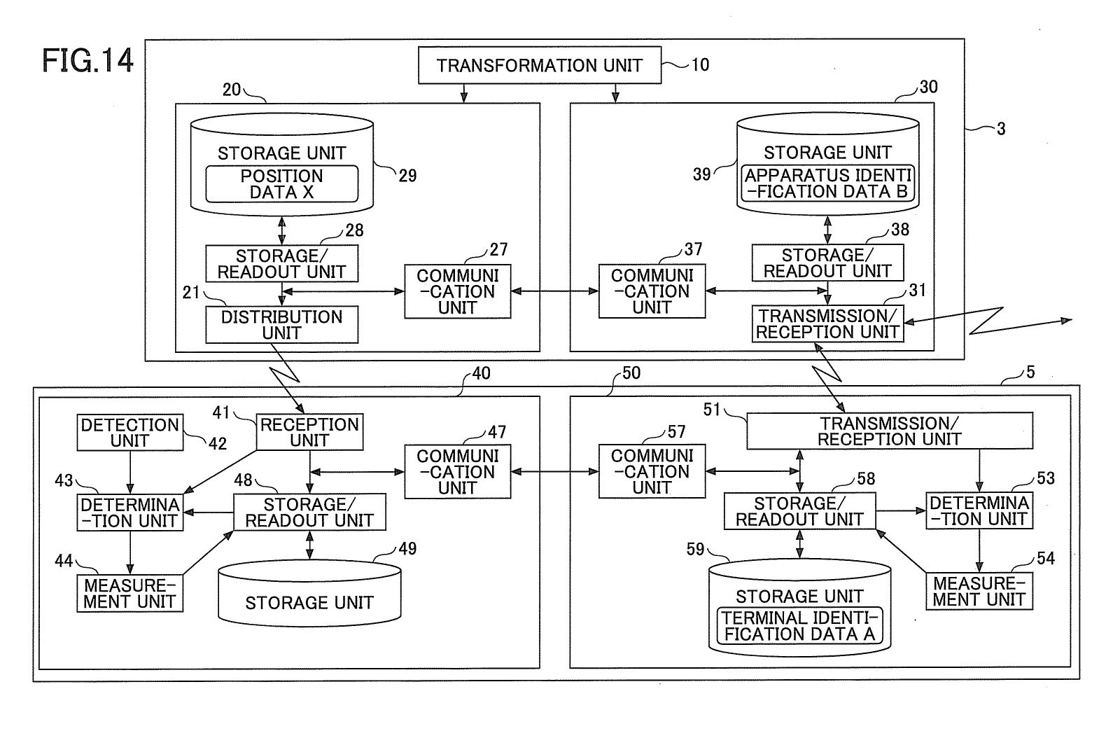

Next, a function configuration of the position management system 1 according to an embodiment of the present invention is described with reference to FIGS. 14-16. Along with describing the functional configuration with reference to FIGS. 14-16, a relationship between the function configuration and the hardware configurations illustrated in FIGS. 10-12 are described.

FIG. 14 is a block diagram illustrating functions (function components) of the distribution apparatus 3 and the communication terminal 5 according to an embodiment of the present invention. As illustrated in FIG. 14, the distribution apparatus 3 includes functions or function components such as a transformation unit 10, a distribution control unit 20, and a wireless communication control unit 30. The transformation unit 10 is a function component (function) that is implemented by operating the voltage transformer 100 illustrated in FIG. 5.

The distribution control unit 20 is a function component (function) that is implemented by operating the control unit 11 and the position data distribution unit 12 illustrated in FIG. 5. The wireless communication control unit 30 is a function component (function) that is implemented by operating the control unit 11 and the wireless communication unit 13 illustrated in FIG. 5.

The distribution control unit 20 includes a storage unit 29 constituted by the ROM 202 illustrated in FIG. 5. The storage unit 29 stores the position data X therein. The distribution control unit 20 includes a distribution unit 21, a communication unit 27, and a storage/readout unit 28.

The distribution unit 21 distributes the position data X within a distributable range. The distribution unit 21 is a function component (function) that is implemented mainly by the processes of the CPU 201 and the communication circuit 204 illustrated in FIG. 5.

The communication unit 27 performs data (signal) communication (i.e. transmits/receives data (signals)) with respect to the wireless communication control unit 30. The communication unit 27 is a function component (function) that is implemented mainly by the processes of the CPUs 101, 201, the interfaces 108a, 208, and the buses 109, 209.

The storage/readout unit 28 stores various data (e.g., position data X) and reads out the stored data. The storage/readout unit 28 is a function component (function) that is implemented mainly by the processes of the CPUs (101, 201).

The wireless communication control unit 30 includes a storage unit 39 that is constituted by the RAM 303 illustrated in FIG. 5. The storage unit 39 stores the apparatus identification data B therein.

A transmission/reception unit 31 transmits/receives various data with respect to the communication unit 5 or the gateway 7 by way of wireless communication. The transmission/reception unit 31 is a function component (function) that is implemented mainly by the processes of the CPU 301 and the communication circuit 304 illustrated in FIG. 5.

A communication unit 37 performs data (signal) communication with respect to the distribution control unit 20. The communication unit 37 is a function component (function) that is implemented mainly by the processes of the CPUs 101, 301, the interfaces 108B, 308, and the buses 109, 309.

A storage/readout unit 38 stores various data in the storage unit 29 and reads out the stored data.

Next, a function configuration of the communication terminal 5 according to an embodiment of the present invention is described.

The communication terminal 5 includes functions or function components such as a reception control unit 40 and a wireless communication control unit 30.

The reception control unit 40 includes a storage unit 49 which is constituted by the RAM 403 illustrated in FIG. 7. The storage unit 49 can store the position data X distributed from the distribution apparatus 3 therein. The reception control unit 40 includes a reception unit 41, a detection unit 42, a determination unit 43, a measurement unit 44, a communication unit 47, and a storage/readout unit 48.

The reception unit 41 receives the position data X distributed from the distribution apparatus 3. Further, the reception unit 41 switches between a state capable of receiving the position data X and a state unable to receive the position data X. The reception unit 41 is a function component (function) that is implemented mainly by the processes of the CPU 401 and the communication circuit 404 illustrated in FIG. 7.

The detection unit 42 detects the movement (including tilt) of the communication terminal 5 and causes the reception unit 41 to start operation (e.g., data reception). The detection unit 42 is a function component (function) that is implemented mainly by the processes of the CPU 401 and the acceleration sensor 405. Instead of the acceleration sensor 405, the function of the detection unit 42 may be implemented with a motion sensor using, for example, inertial force or magnetic force.

The determination unit 43 determines whether at least a single position data X has been received by the reception unit 41. Further, the determination unit 43 determines whether the position data X corresponding to each one of multiple distribution apparatuses 3 has been received by the reception unit 41. The determination unit 43 is a function component (function) that is implemented mainly by the processes of the CPU 401 illustrated in FIG. 7. In a case where the position data X is received from the same distribution apparatus 3 for a multiple number of times within the below-described predetermined time, the multiply received distribution data X are handled as a single distribution data.

In a case where the determination unit 43 determines that position data X corresponding to each of the multiple distribution apparatuses 3 have been received, the measurement unit 44 measures the signal strength of each of the position data X received from the multiple distribution apparatuses 3. The measurement unit 44 is a function component (function) that is implemented mainly by the CPU 401 illustrated in FIG. 7.

The communication unit 47 performs data (signal) communication with respect to the wireless communication unit 50. The communication unit 47 is a function component (function) that is implemented mainly by the processes of the CPU 401, the I/F 408, and the bus 409 illustrated in FIG. 7.

The storage/readout unit 48 stores various data (e.g., position data X) in the storage unit 49 and reads out the stored data from the storage unit 49. The storage/readout unit 48 is a functional component (function) that is implemented by the CPU 401.

The wireless communication unit 50 includes a storage unit 59 which is constituted by the RAM 503 illustrated in FIG. 5. The storage unit 59 stores the position data A therein. The wireless communication unit 50 also includes a transmission/reception unit 51, a determination unit 53, a measurement unit 54, a communication unit 57, and a storage/readout unit 58.

The transmission/reception unit 51 transmits/receives various data with respect to the distribution apparatus 3 by way of wireless communication. The transmission/reception unit 51 is a function component (function) implemented mainly by the CPU 501 and the communication circuit 504 illustrated in FIG. 7.

The determination unit 53 determines whether at least a single apparatus identification data B has been received by the reception unit 51. Further, the determination unit 53 determines whether the apparatus identification data B corresponding to each one of multiple distribution apparatuses 3 has been received by the reception unit 51. The determination unit is a function component (function) that is implemented mainly by the processes of the CPU 501 illustrated in FIG. 7. In a case where the apparatus identification data B is received from the same distribution apparatus 3 for a multiple number of times within the below-described predetermined time, the multiply received apparatus identification data B are handled as a single apparatus identification data.

In a case where the determination unit 53 determines that apparatus identification data B corresponding to each of the multiple distribution apparatuses 3 have been received, the measurement unit 54 measures the signal strength of each of the apparatus identification data B received from the multiple distribution apparatuses 3. The measurement unit 54 is a function component (function) that is implemented mainly by the CPU 501 illustrated in FIG. 7.

The communication unit 57 performs data (signal) communication with respect to the reception control unit 40. The communication unit 57 is a function component (function) that is implemented mainly by the processes of the CPU 501, the I/F 508, and the bus 509 illustrated in FIG. 7.

The storage/readout unit 58 stores various data (e.g., apparatus identification data A, B) in the storage unit 59 and reads out the stored data from the storage unit 59. The storage/readout unit 58 is a function component (function) that is implemented by the CPU 501.

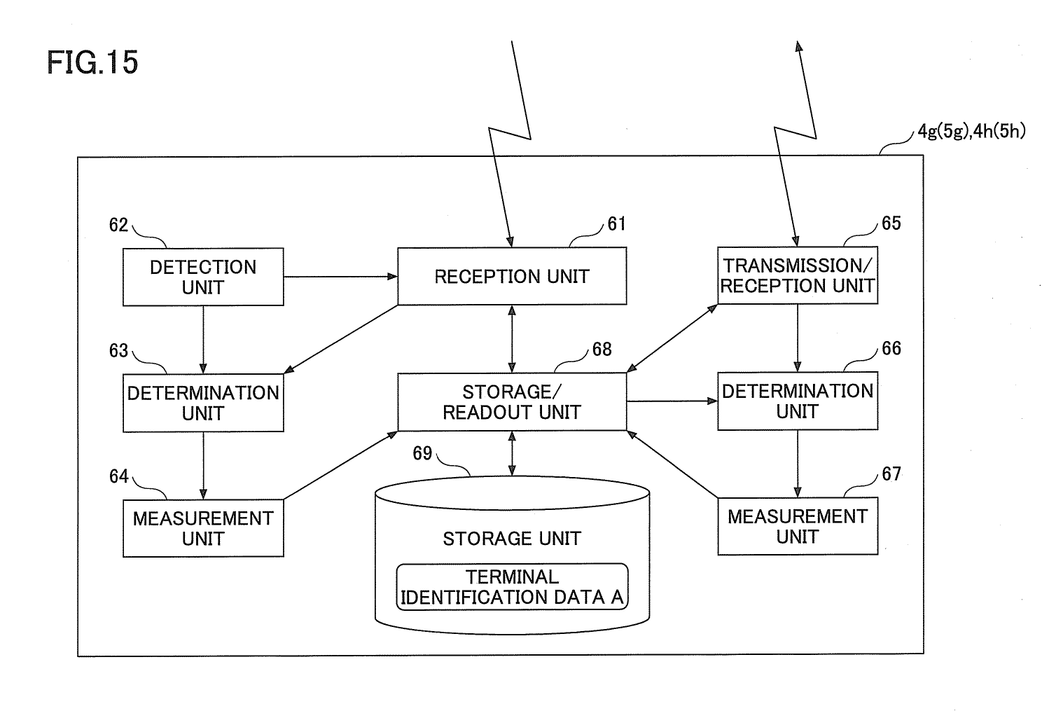

Next, a function configuration of a management object (4g, 4h) is described with reference to FIG. 15. FIG. 15 is a block diagram illustrating functions (function components) of the management object 4 in a case where the management object is a personal computer 4g or a mobile phone 4h.

As illustrated in FIG. 15, the management object (4g, 4h) includes a storage unit 69 that is constituted by the EEEPROM 604 illustrated in FIG. 10 or the RAM 903 and the HD 904 illustrated in FIG. 12. The management object (4g, 4h) also includes a reception unit 61, a detection unit 62, a determination unit 63, a measurement unit 64, a determination unit 66, a measurement unit 67, and a storage/readout unit 68.

The reception unit 61 has the same function as the reception unit 41. The reception unit 61 is a function component (function) that is implemented mainly by the processes of the CPU 601 and the GPS unit 614 illustrated in FIG. 10 or the processes of the CPU 901 and the GPS antenna connected to the external device I/F unit 916 illustrated in FIG. 12.

The detection unit 62 has the same function as the detection unit 42. The detection unit 62 is a function component (function) that is implemented mainly by the processes of the CPU 601 and the acceleration/bearing sensor 606 illustrated in FIG. 10 or the processes of the CPU 901 and the acceleration sensor connected to the external device I/F 916 illustrated in FIG. 12.

The determination unit 63 has the same function as the determination unit 43. The determination unit 63 is a function component (function) that is implemented mainly by the processes of the CPU 601 illustrated in FIG. 10 or the processes of the CPU 901 illustrated in FIG. 12.

The measurement unit 64 has the same function as the measurement unit 44. The measurement unit 64 is a function component (function) that is implemented mainly by the CPU 601 illustrated in FIG. 10 or the processes of the CPU 901 illustrated in FIG. 12.

The transmission/reception unit 65 has the same function as the transmission/reception unit 51. The transmission/reception unit 65 is a function component (function) that is implemented mainly by the processes of the CPU 601 and the communication unit 613 illustrated in FIG. 10 or the processes of the CPU 901 and the communication unit 915 illustrated in FIG. 12.

The determination unit 66 has the same function as the determination unit 53. The determination unit 66 is a function component (function) that is implemented mainly by the processes of the CPU 601 illustrated in FIG. 10 or the processes of the CPU 901 illustrated in FIG. 12.

The measurement unit 67 has the same function as the measurement unit 54. The measurement unit 67 is a function component (function) that is implemented mainly by the CPU 601 illustrated in FIG. 10 or the processes of the CPU 901 illustrated in FIG. 12.

The storage/readout unit 68 has the same function as the storage/readout unit 48 or the storage/readout unit 58. The storage/readout unit 68 is a function component (function) that is implemented mainly by the CPU 601 illustrated in FIG. 10 or the processes of the CPU 901 illustrated in FIG. 12.

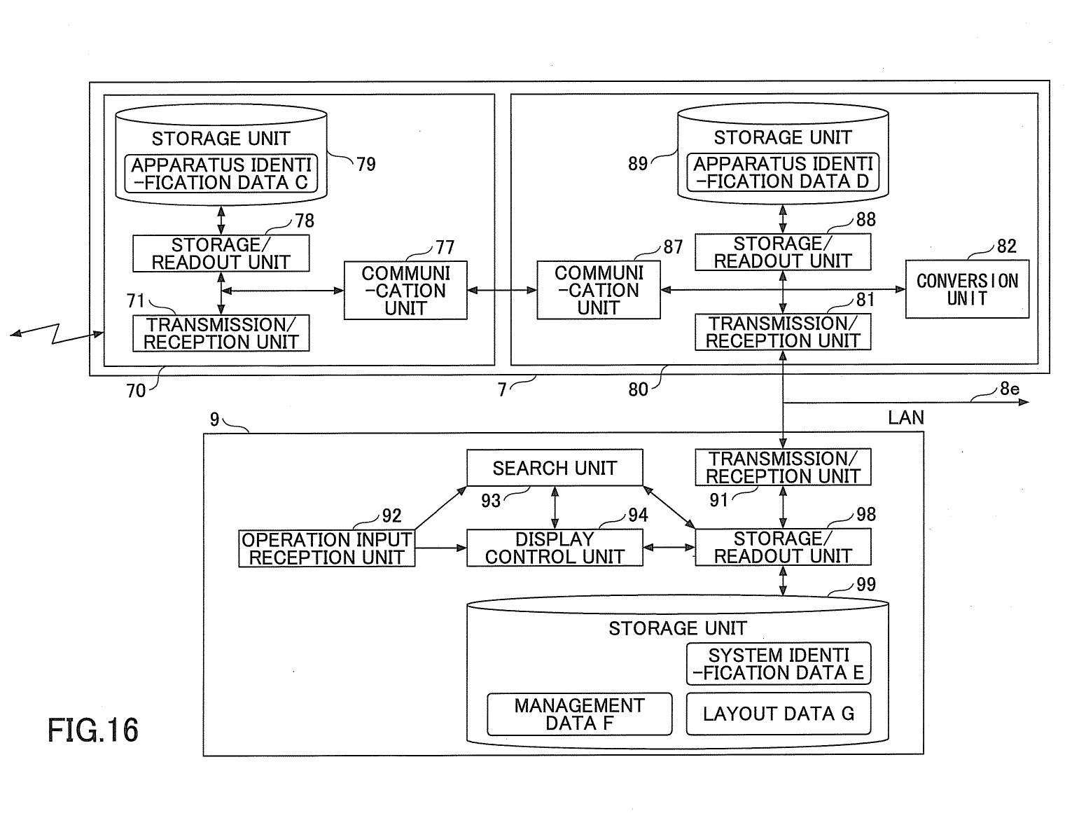

Next, a function configuration of the gateway 7 according to an embodiment of the present invention is described with reference to FIG. 16. FIG. 16 is a block diagram illustrating functions (function components) of the gateway 7 and the position data management system 9 according to an embodiment of the present invention.

The gateway 7 includes functions or function components such as a wireless communication control unit 70 and a wired communication control unit 80.

The wireless communication control unit 70 basically has the same function as the wireless communication control unit 30 of the distribution apparatus 3. The wireless communication control unit 70 is a function component (function) that is implemented by the processes of the wireless communication unit 17 illustrated in FIG. 11.

The wireless communication control unit 70 includes a storage unit 79 that is constituted by the RAM 703 illustrated in FIG. 11. The storage unit 79 has the apparatus identification data C stored therein. The wireless communication control unit 70 also includes a transmission/reception unit 71, a communication unit 77, and a storage/readout unit 78.

The transmission/reception unit 71 transmits/receives various data with respect to the distribution apparatus 3 by way of wireless communication. The transmission/reception unit 71 is a function component (function) that is implemented mainly by the processes of the CPU 701 and the communication circuit 704 illustrated in FIG. 11.

The communication unit 77 performs data (signal) communication with respect to the wired communication control unit 80. The communication unit 77 is a function component (function) that is implemented mainly by the CPU 701, the I/F 708, and the bus 709.

The storage/readout unit 78 stores various data in the storage unit 79 and reads out the stored data from the storage unit 79. The storage/readout unit 78 is a function component (function) that is implemented mainly by the CPU 801.

The wired communication control unit 80 includes a storage unit 89 constituted by the RAM 803 illustrated in FIG. 11. The storage unit 89 has the apparatus identification data D stored therein. The wired communication control unit 80 also includes a transmission/reception unit 81, a conversion unit 82, a communication unit 87, and a storage/readout unit 88. The wired communication control unit 80 is a function component (function) implemented by the wired communication unit 18 illustrated in FIG. 11.

The transmission/reception unit 81 transmits/receives data with respect to the position data management system 9 by way of wired communication. The transmission/reception unit 81 is a functional component (function) that is implemented mainly by the processes of the CPU 801 and the I/F 808b illustrated in FIG. 11.

The conversion unit 82 performs controls for converting communication methods, so that Ethernet packet communication can be performed with the various data transmitted from the distribution apparatus 3. The conversion unit 82 is a function component (function) that is implemented mainly by the CPU 801 and the Ethernet controller 805 illustrated in FIG. 11.

The communication unit 87 performs data (signal) communication with respect to the wireless communication control unit 70. The communication unit 87 is a function component (function) implemented mainly by the processes of the CPU 801, the I/F 808a, and the bus 809.

The storage/readout unit 98 stores various data in the storage unit 89 and reads out the stored data from the storage unit 89. The storage/readout unit 98 is a function component (function) that is implemented mainly by the processes of the CPU 801.

Next, a function configuration of the position data management system 9 according to an embodiment of the present invention is described with reference to FIG. 16.

The position data management system 9 includes a storage unit 99 that is constituted by the RAM 903 and the HD 904 illustrated in FIG. 12. The storage unit 99 has the system identification data E, the management data F, and the layout data G stored therein. The position data management system 9 also includes a transmission/reception unit 91, an operation input reception unit 92, a search unit 93, a display control unit 94, and a storage/readout unit 98.

The transmission/reception unit 91 transmits/receives various data with respect to the gateway 7 by way of wired communication or wireless communication. Further, the transmission/reception unit 91 transmits/receives various data with respect to the communication terminal 5h in the outdoor area γ via the communication network 8. The transmission/reception unit 91 is a function component (function) that is implemented mainly by the processes of the CPU 901 and the network I/F or the communication circuit 915 illustrated in FIG. 12.

The operation input reception unit 92 receives various inputs or selections from the administrator of the position data management system 9. The operation input reception unit 92 is a function component (function) that is implemented mainly by the processes of the CPU 901 and the keyboard 911, and the mouse 912.

The search unit 93 searches the management data F of the storage unit 99 by way of the storage/readout unit 98 based on search conditions input to the operation input reception unit 92. The search unit 93 is a function component (function) that is implemented mainly by the processes of the CPU 901.

The display control unit 94 performs controls for displaying various data (e.g., images, characters) on the display 908. The display control unit 94 is a function component (function) that is implemented mainly by the processes of the CPU 901.

The storage/readout unit 98 stores various data in the storage unit 99 and reads out stored data from the storage unit 99. The storage/readout unit 98 is a function component (function) that is implemented mainly by the processes of the CPU 901.

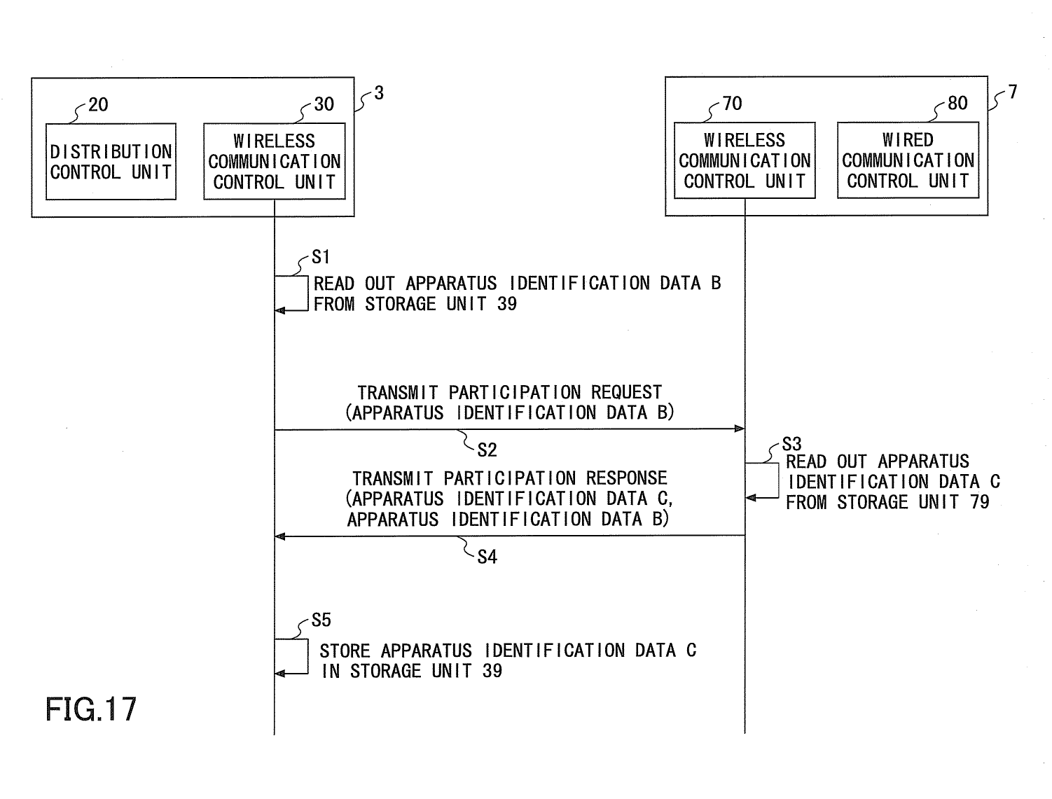

Next, operations according to an embodiment of the present invention are described with reference to FIGS. 17 and 25.

First, an operation of establishing (building) a communication network in the ceiling β of the indoor area α is described with reference to FIG. 17. FIG. 17 is a sequence diagram illustrating an operation of establishing a communication network in a ceiling.

First, when a user switches on the power of each electric device 2 in the indoor area α, the storage/readout unit 38 (see FIG. 14) of the wireless communication control unit 30 in each distribution apparatus 3 reads out apparatus identification data B from the storage unit 39 (Step S1). Then, the transmission/reception unit 31 transmits a participation request including the apparatus identification data B of the distribution apparatus 3 itself to the gateway 7 (Step S2). Thereby, the transmission/reception unit 71 of the wireless communication control unit 70 of the gateway 7 receives the participation request.

Then, the storage/readout unit 78 of the wireless communication control unit 70 reads out the apparatus identification data C from the storage unit (Step S3). Then, the transmission/reception unit 71 transmits a participation response including the apparatus identification data B, C (Step S4) to the distribution apparatus 3. Thereby, the transmission/reception unit 31 of the wireless communication control unit 30 of the distribution apparatus 3 receives the participation response. Because the participation response includes the apparatus identification data B transmitted in Step S2, the wireless communication unit 30 performs the process of receiving the participation response of Step S4 in association with the process of transmitting the participation request of Step S2. Then, the storage/readout unit 38 stores the apparatus identification data C in the storage unit (Step S5). Accordingly, by storing the apparatus identification data C of the gateway 7 at the side of the distribution apparatus 3, a communication network between the distribution apparatus 3 and the gateway 7 can be established.

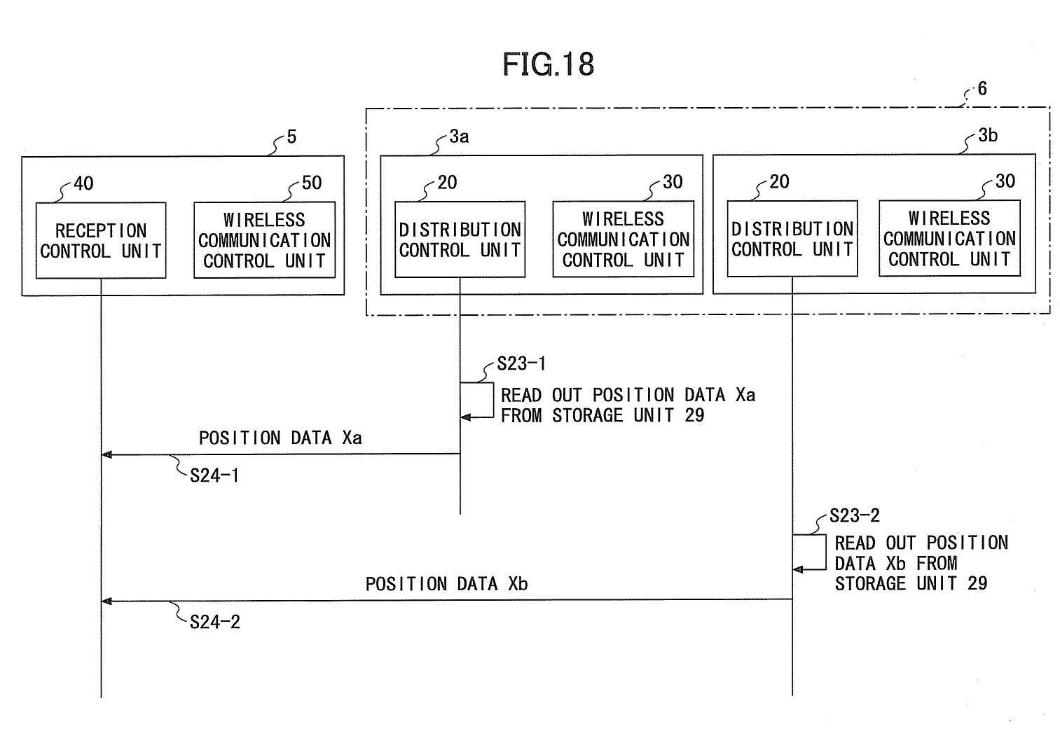

Next, an operation of distributing position data X from the ceiling β in the direction of the floor of the indoor area α (as illustrated in FIG. 1) is described with reference to FIG. 18. FIG. 18 is a sequence diagram illustrating an operation of distributing position data X according to an embodiment of the present invention. For the sake of convenience, FIG. 18 illustrates an example where a distribution system 6 is constituted by two distribution apparatuses 3a, 3b. In the example of FIG. 18, the distribution apparatus 3a distributes position data Xa and the distribution apparatus 3b distributes position data Xb. In the example of FIG. 18, the communication terminal 5 is positioned within a range (distributable range) in which position data Xa, Xb are distributable from the distribution apparatuses 3a, 3b, respectively.

First, the storage/readout unit 28 of the distribution control unit 20 of the distribution apparatus 3a reads out position data Xa of the distribution apparatus 3a itself from the storage unit 29 (Step S23-1). Then, the distribution unit 21 of the distribution control unit 20 of the distribution apparatus 3a distributes the position data Xa within the distributable range (Step S24-1). Likewise, the storage/readout unit 28 of the distribution control unit 20 of the distribution apparatus 3b reads out position data Xb of the distribution apparatus 3b itself from the storage unit 29 (Step S23-2). Then, the distribution unit 21 of the distribution control unit 20 of the distribution apparatus 3b distributes the position data Xb within the distributable range (Step S24-2). It is, however, to be noted that the communication terminal 5 is unable to receive the position data Xa, Xb if operation of the reception part 41 of the communication terminal 5 is not started.

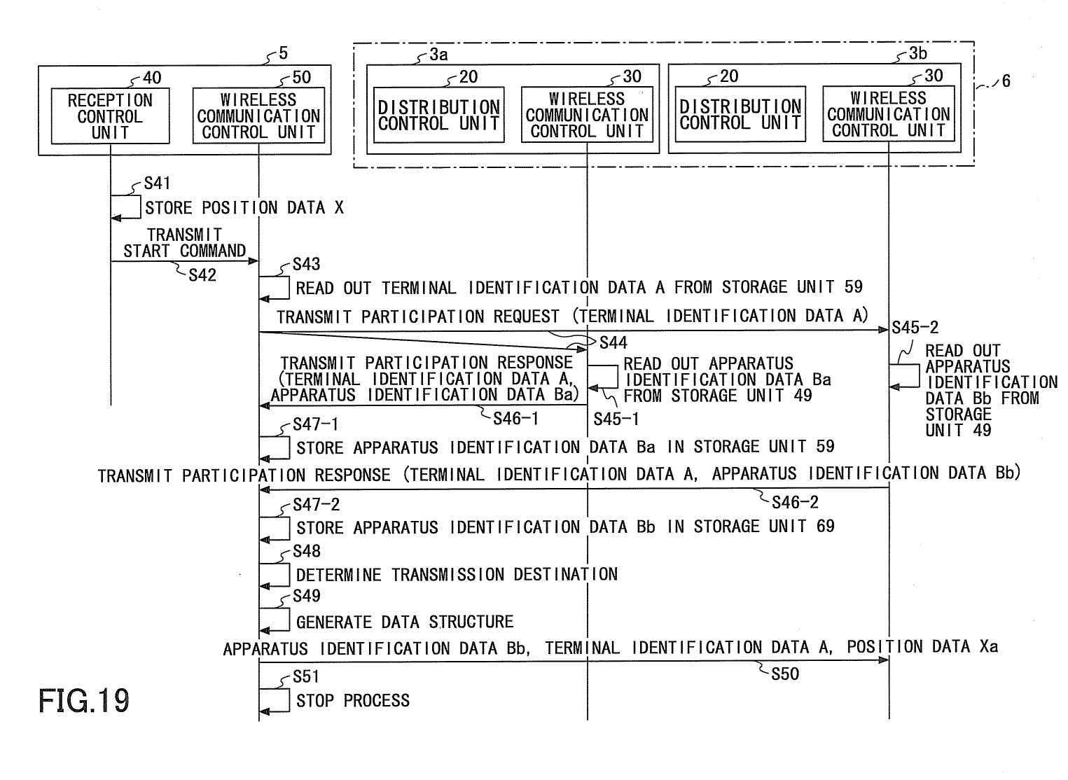

Next, an operation of determining the position data X to be used by the communication terminal 5 and determining the transmission destination of the position data X is described with reference to FIG. 19. FIG. 19 is a sequence diagram illustrating an operation of determining the position data X to be used by the communication terminal 5 and determining the transmission destination of the position data X. FIG. 19 illustrates an example of receiving the position data X transmitted from the distribution apparatus Xa with the communication terminal but transmitting the position data Xa to the distribution apparatus Xb rather than the transmission source of the position data Xa (i.e. rather than the distribution apparatus Xa).

First, as illustrated in FIG. 19, the storage/readout unit 48 of the reception control unit 40 of the communication terminal 5 stores one of the position data Xa, Xb distributed by the distribution apparatus 3a, 3b in the storage unit 49 (Step S41). Among the position data Xa, Xb distributed by the distribution apparatus 3a, 3b, the position data that is to be stored in the storage unit 49 is the position data having the highest signal strength among the position data Xa, Xb when received by the communication terminal 5. Accordingly, the position indicated by the position data X stored in the storage unit 49 (i.e. one of the position data Xa or Xa in the example of FIG. 19) is to be managed as the position of the communication terminal 5 in a subsequent process by the position data management system 9.

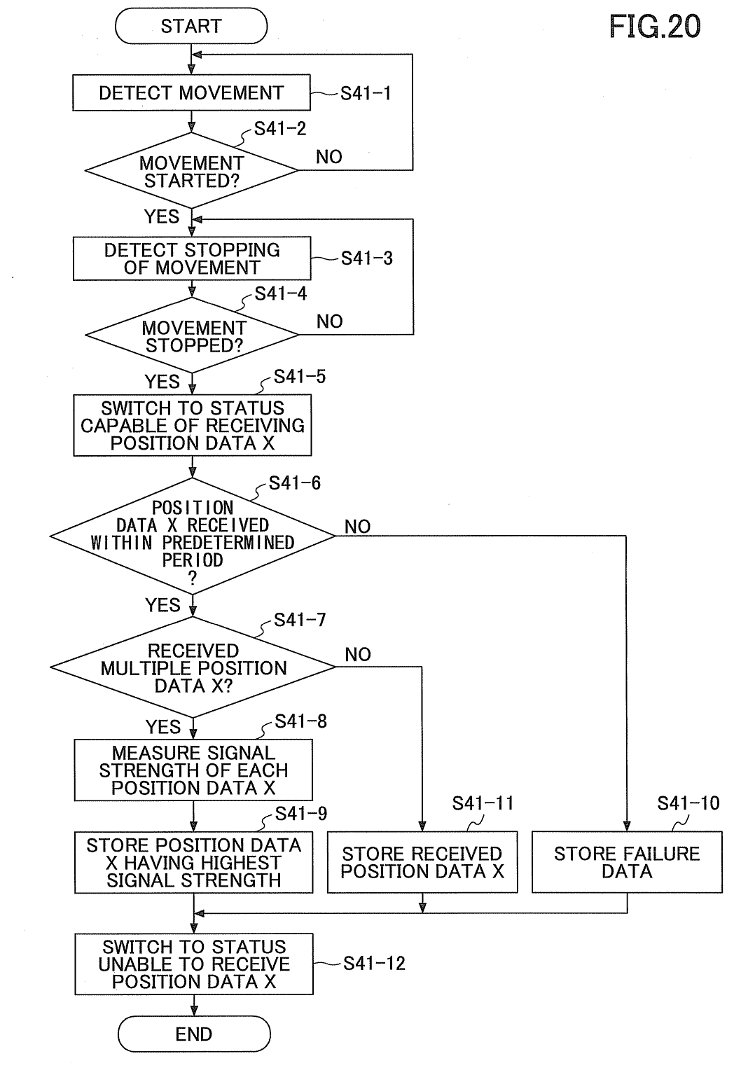

The process performed in Step S41 is described in further detail with reference to FIG. 20. FIG. 20 is a flowchart illustrating an operation that begins when position data X is received by the communication terminal 5 and ends when the position data X is stored by the communication terminal 5 according to an embodiment of the present invention.

First, the detection unit 42 of the reception control unit 40 of the communication terminal 5 starts and continues to detect the starting of movement of the communication terminal 5 (Step S41-1, No in Step S41-2). Then, in a case where the detection unit 42 detects the starting of movement of the communication terminal 5 (Yes in Step S41-2), the detection unit 42 starts and continues to detect the stopping of movement of the communication terminal 5 (Step S41-3, S41-4). More specifically, in a case where operation (processing) of the CPU 401 of FIG. 7 is in a stopped state, the acceleration sensor 405, upon detecting change of acceleration, transmits a signal indicating the starting of movement of the communication terminal (i.e. signal instructing the CPU 401 to start operating) to the CPU 401. Thereby, the CPU 401 starts to operate (processing). Then, the CPU 401 maintains a state of operating until receiving a signal from the acceleration sensor 405 indicating that the movement of the communication terminal 5 has stopped. It is to be noted that movement of the communication terminal 5 includes tilting of the communication terminal 5.

Then, in a case where the detection unit 42 detects the stopping of movement of the communication terminal 5 (Yes in Step S41-4), the reception unit 41 switches to a state capable of receiving position data distributed from the distribution apparatus 3 (Step S41-5). More specifically, in a case where the CPU 407 of FIG. 7 receives a signal indicating the stopping of movement of the communication terminal 5 from the acceleration sensor 505, the CPU 407 transmits a signal to the communication circuit 404 instructing the communication circuit 404 to start operating. Thereby, the communication circuit 404 starts to operate. In a case where position data Xa, Xb are received from the distribution apparatus 3a and 3b, the communication circuit 404 of the control unit 14 of the communication terminal 5 starts reception of position data Xa, Xb by way of the antenna 404a.

Then, after the reception unit 41 is switched to the state capable of receiving the position data X, the determination unit 43 determines whether at least a single position data X has been received within a predetermined time (e.g., within 5 seconds) (Step S41-6). In the description of the example of FIG. 20, it is assumed that position data Xa and Xb have been received within the predetermined time.

In a case where the determination unit 43 determines that at least a single position data X has been received within the predetermined time (Yes in Step S41-6), the determination unit 43 determines whether multiple position data X have been received (Step S41-7).

In a case where the determination unit 43 determines that multiple position data X have been received (Yes in Step S41-7), the measurement unit 44 measures the signal strength of each of the multiple position data X upon receipt by the reception unit 41 (Step S41-8). In the example of FIG. 20, it is assumed that the signal strength of the position data Xa is stronger than the signal strength of the position data Xb as a result of the measurement by the measurement unit 44.

Then, the storage/readout unit 48 stores the position data X having the highest signal strength in the storage unit 49 according to the measurement of Step S41-8 (Step S41-9). In this example, the position data Xa is stored in the storage unit 49.

In a case where the determination unit 43 determines that not a single position data X has been received within the predetermined time (No in Step S41-6), the storage/readout unit 43 stores failure data indicating failure of receiving position data X in the storage unit 49 (Step S41-10).

Further, in a case where the determination unit 43 determines that multiple position data have not been received within the predetermined time (No in Step S41-7), the storage/readout unit 48 stores the single position data X in the storage unit 49 (Step S41-11).

Then, after the processes in Steps S41-9, S41-10, or S41-11, the reception unit 41 switches to a state of being unable to receive the position data X (Step S41-12). More specifically, the CPU 407 of FIG. 7 transmits a signal to the communication circuit 404 instructing the communication circuit 404 to stop operating. Accordingly, because the reception of the position data X is performed only after the moving of the communication terminal is stopped, the frequency of performing battery change can be reduced even where a small capacity battery such as the button battery 406 is used. This contributes to power saving (energy saving).

As described above, the reception unit 41 is switched to a state capable of receiving the position data X after the starting of movement of the communication terminal 5 (Yes in Step S41-2) and the stopping of movement of the communication terminal (Yes in Step S41-4). In other words, the trigger for switching the reception unit 41 to a state capable of receiving position data is the execution (detection) of both the starting of movement of the communication terminal 5 and the stopping of movement of the communication terminal 5. Alternatively, the reception unit 41 may be switched to a state capable of receiving the position data X after the starting of movement of the communication terminal 5 (Yes in Step S41-2). In other words, the processes of Step S41-3 and S41-4 may be omitted, so that the trigger for switching the reception unit 41 to a state capable of receiving position data is the execution (detection) of the starting of movement of the communication terminal 5. Alternatively, the processes of Step S41-1 and S41-2 may be omitted, so that the trigger for switching the reception unit 41 to a state capable of receiving position data is the execution (detection) of the stopping of movement of the communication terminal 5.

Then, returning to FIG. 19, the communication unit 47 of the reception control unit 40 transmits a command (start command) to the wireless communication control unit 50 instructing to start operating (Step S42). Thereby, when the communication unit 57 of the wireless communication unit 50 receives the start command, the performing of the following processes is started.

First, the storage/readout unit 58 of the wireless communication control unit 50 of the communication terminal 5 reads out the terminal identification data A of the communication terminal 5 itself from the storage unit 59 (Step S43). Then, the transmission/reception unit 51 transmits a participation request including the terminal identification data A to the distribution apparatuses 3a, 3b. Each of the distribution apparatuses 3a, 3b receives the participation request from the communication terminal 5.

Then, the storage/readout unit 38 of the wireless communication unit 30 of the distribution apparatus 3a reads out the apparatus identification data Ba of the distribution apparatus 3a itself from the storage unit 39 (Step S45-1). Then, the transmission/reception unit 31 of the distribution apparatus 3a transmits a participation response including the terminal identification data A and the apparatus identification data Ba to the communication terminal 5 (Step S46-1). Thereby, the transmission/reception unit 51 of the wireless communication control unit 50 of the communication terminal 5 receives the participation response. Because the terminal identification data A transmitted in Step S44 is included in the participation response, the communication terminal 5 performs the process of receiving the participation response of Step S46-1 in association with the process of transmitting the participation request of Step S44. Then, the storage/readout unit 58 of the wireless communication control unit 50 of the communication terminal 5 stores the apparatus identification data Ba in the storage unit 59 (Step S47-1).

Similarly, at the side of the distribution apparatus 3b, the storage/readout unit 38 of the wireless communication control unit 30 of the distribution apparatus 3b reads out the apparatus identification data Bb of the distribution apparatus 3b itself from the storage unit 39 (Step S45-2). Then, the transmission/reception unit 31 of the distribution apparatus 3b transmits a participation response including the terminal identification data A and the apparatus identification data Bb to the communication terminal 5 (Step S46-2). Thereby, the transmission/reception unit 51 of the wireless communication control unit 50 of the communication terminal 5 receives the participation response. Then, the storage/readout unit 58 of the wireless communication control unit 50 of the communication terminal 5 stores the apparatus identification data Bb in the storage unit 59 (Step S47-2).

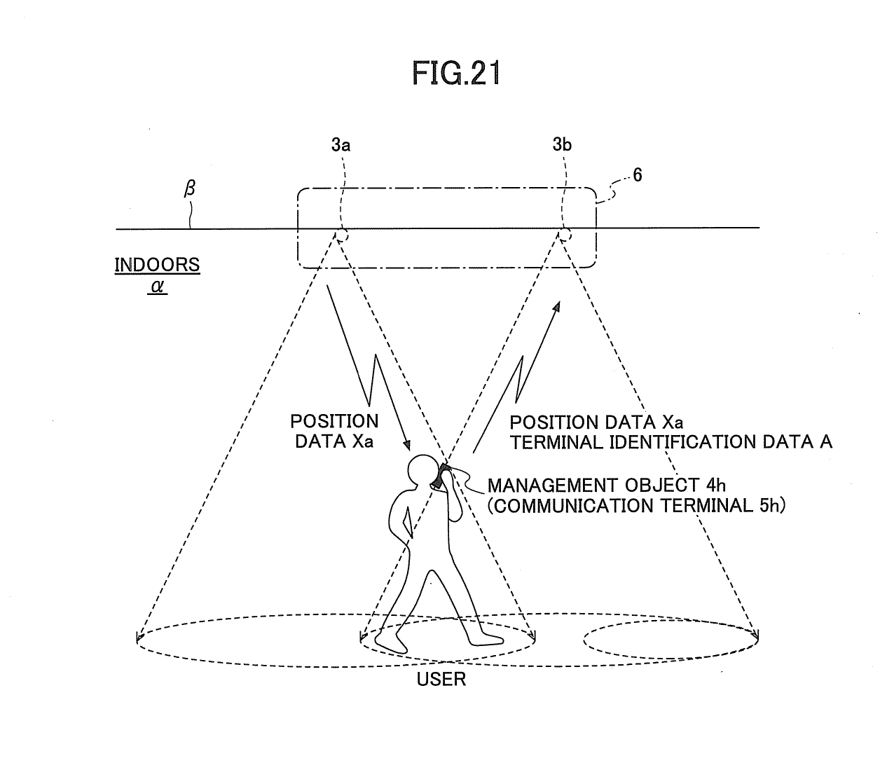

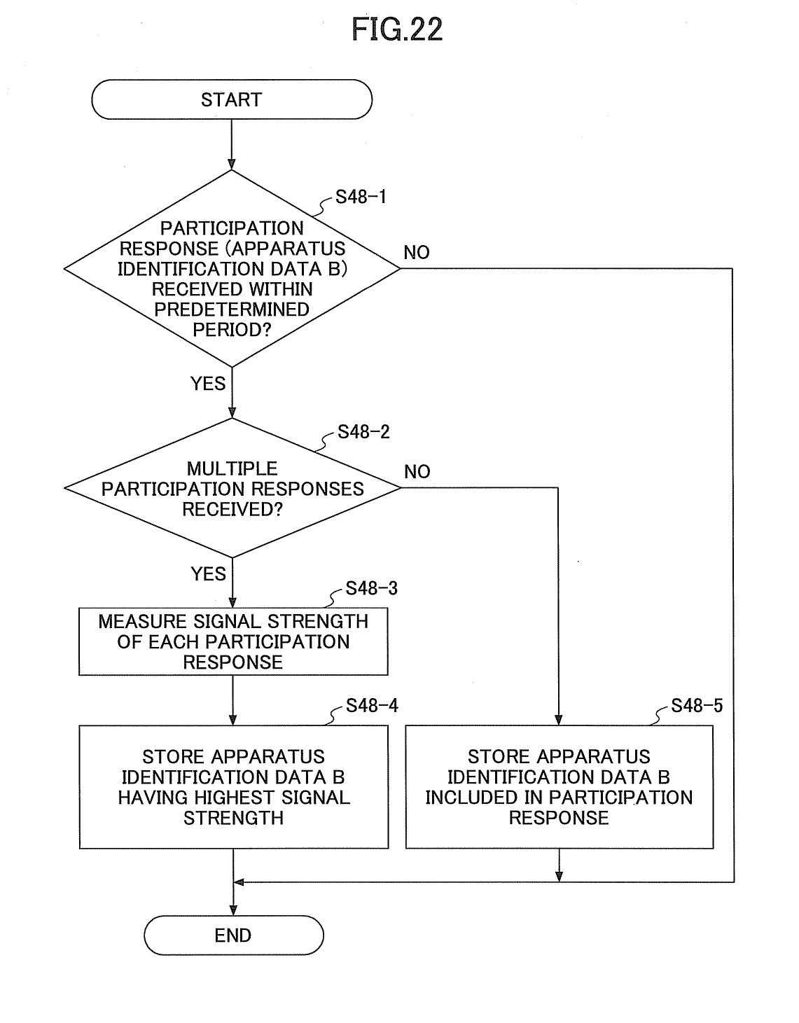

Then, the wireless communication control unit 50 determines the position data X received from the distribution apparatus 3 and the distribution apparatus 3 (transmission destination) to which the terminal identification data A of the communication terminal 5 itself is to be transmitted (Step S48). Next, the process of Step S48 is described in detail with reference to FIG. 22. Before describing the process of Step S48, the background of the process of Step S48 is described with reference to FIGS. 5, 14, and 21. FIG. 21 is a schematic diagram illustrating a state of communication between the distribution apparatus 3 and the communication terminal 5.

As illustrated in FIG. 14, the communication between the distribution control unit 20 of the distribution apparatus 3 and the reception control unit 40 of the communication terminal 5 is separate from the communication between the wireless communication control unit 30 of the distribution apparatus 3 and the wireless communication control unit 50 of the communication terminal 5. Further, the reception control unit 40 receives the position data X from the distribution apparatus 3 that is the distribution source whereas the wireless communication control unit 50 transmits (returns) the position data X together with the terminal identification data A of the communication terminal 5 itself to the distribution apparatus 3.

However, if the distribution control unit 20 and the wireless communication control unit 30 are to be provided in all of the distribution apparatuses, the cost for installing the distribution apparatuses would be significantly high in a case where the distribution apparatuses 3 are provided in the indoor area α covering a large area (large floor space) (Pattern 1).

Further, there may be a case where the distribution apparatus 3a can distribute the position data Xa but cannot receive the terminal identification data A and the position data Xa from the communication terminal 5 due to, for example, malfunction of the wireless communication control unit 30 of the distribution apparatus 3 (Pattern 2).

Further, in a case where multiple distribution apparatuses 3 (3a, 3b) are installed to the ceiling β, there may be a case where the signal strength of the data of the participation response received from the wireless communication control unit 30 of the distribution apparatus 3b is higher than the signal strength of the data of the participation response received from the wireless communication control unit 30 of the distribution apparatus 3a (see Step S46-1, 46-2) depending on the position of the communication terminal 5 in the indoor area α even if the signal strength of the position data X received from the distribution control unit 20 of the distribution apparatus 3a is higher than the signal strength of the position data X received from the distribution control unit 20 of the distribution apparatus 3b (see Step S24-1, 24-2) (Pattern 3).

In the above-described Patterns 1-3, although the communication terminal 5 receives position data Xa from the distribution apparatus 3a (distribution source), the communication terminal 5 transmits the terminal identification data A of the communication terminal 5 itself and the position data Xa to a distribution apparatus 3 other than the distribution apparatus 3a (in this case, distribution apparatus 3b) as illustrated in FIG. 21. In the following, the above-described case where the distribution apparatus 3 of the distribution source is different from distribution apparatus 3 of the transmission destination is described with reference to FIGS. 14 and 20.

The determination unit 53 of the wireless communication control unit 50 of the communication terminal 5 illustrated in FIG. 14 determines whether at least a single participation response is received within a predetermined time (e.g., 5 seconds) with respect to the transmission of the participation request from the transmission/reception unit 51 to each of the distribution apparatuses 3a, 3b (Step S48-1). That is, the determination unit 53 determines whether at least a single apparatus identification data B is received within a predetermined time with respect to the starting of the transmission of the terminal identification data A.

Then, in a case where the determination unit 53 determines that at least a single participation response is received (Yes in Step S48-1), the determination unit 53 further determines whether multiple participation responses have been received (Step S48-2). That is, the determination unit 53 determines whether multiple apparatus identification data B have been received within the predetermined time with respect to the starting of the transmission of the terminal identification data A.

In a case where the determination unit 53 determines that multiple participation responses have been received (Yes in Step S48-2), the measurement unit 54 measures the signal strength of each of the participation responses upon receipt by the transmission/reception unit 51 (Step S48-3). In this example, the process of Step S48-3 is executed because the wireless communication control unit 50 of the communication terminal 5 receives participation responses from the distribution apparatus 3a, 3b in Step S46-1, S46-2.

Next, a case where the determination unit 53 determines that signal strength of the participation response from the distribution apparatus 3b is higher than the signal strength of the participation response (according to the measurement results of Step S48-3) is described. As illustrated in FIG. 22, the storage/readout unit 58 stores the apparatus identification data B (in this example, apparatus identification data Bb) included in the participation response having the highest signal strength in the storage unit 59 according to the measurement of Step S48-3 (Step S48-4).

In a case where the determination unit 53 determines that not a single participation response has been received within the predetermined time (No in Step S48-1), the process of determining the transmission destination is terminated. Further, in a case where the determination unit 53 determines that multiple participation responses have not been received within the predetermined time (No in Step S48-2), the storage/readout unit 58 stores the apparatus identification data B included in the single participation response in the storage unit 59 (Step S48-5).

Thereby, the distribution apparatus 3 indicated with the apparatus identification data B in the storage unit 59 (stored by the storage/readout unit 58) is determined as the destination (transmission destination) to which data is to be transmitted from the communication terminal 5.

Then, after the processes of Step S48-4 or Step S48-5, the transmission/reception unit 51 generates a data structure (as illustrated in FIG. 9) of the data to be transmitted to the transmission destination determined according to Step S48 (Step S49). In this example, the data structure generated by the transmission/reception unit 51 includes the apparatus identification data Bb of the distribution apparatus 3b (transmission destination), the terminal identification data Ah of the communication terminal 5h (transmission source), and the data content (e.g., position data Xa of the distribution apparatus 3a (distribution source)) that are sequentially arranged.

Then, in the communication terminal 5h, the operation of the transmission/reception unit 51, the determination unit 53, the measurement unit 54, the communication unit 57, and the storage/readout unit 58 of the wireless communication control unit 50 stop operating (Step S51). Accordingly, by stopping operation (processing) of the function components (functions) constituting the communication control unit 50 after the transmission/reception unit 51 completes transmitting the data including the position data X to the distribution apparatus 3, power can be saved. The function components (functions) constituting the communication control unit 50 can restart operation (processing) when a new start command is received from the reception control unit 40 in Step S42.

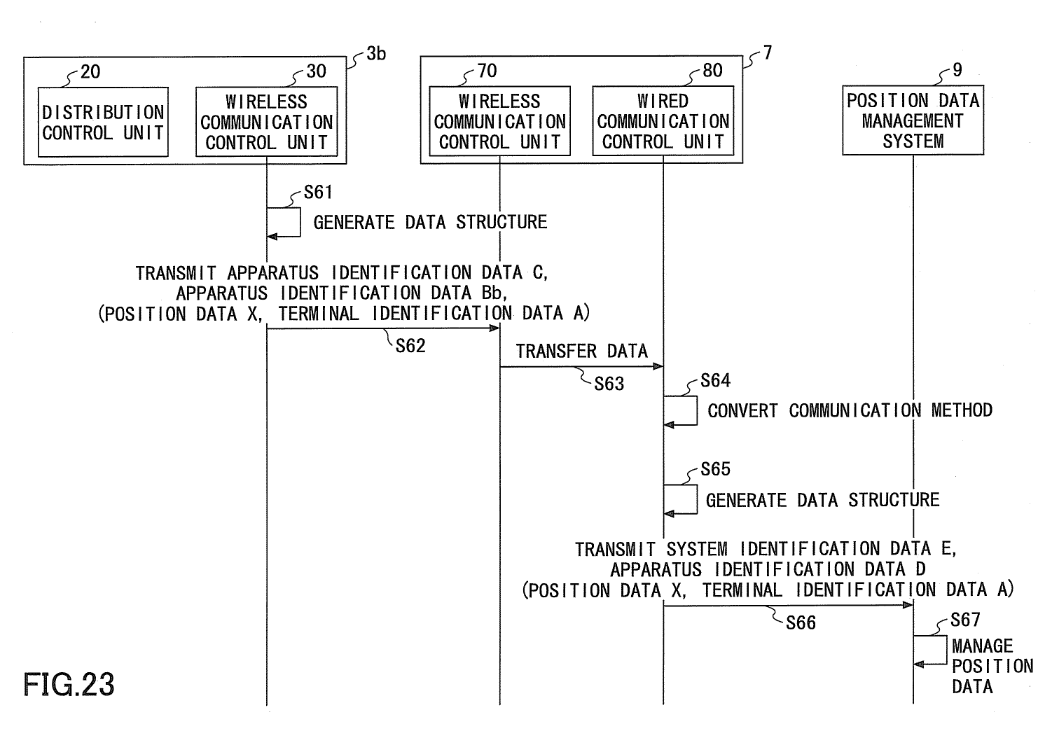

Next, an operation which starts by the distribution apparatus 3 receiving the data including the position data X and ends by the position data management system 9 managing the management data F is described with reference to FIG. 23. FIG. 23 is a sequence diagram illustrating mainly a process of managing position data X.

As illustrated in FIG. 23, first, the wireless communication control unit 30 of the distribution apparatus 3 generates data to be transmitted to the gateway 7. The wireless communication control unit 30 generates a data structure in a similar manner as the Step S49 (Step S61). In this example, the data structure generated by the wireless communication control unit 30 includes the apparatus identification data C of the gateway 7 (transmission destination), the apparatus identification data Bb of the distribution apparatus 3b (transmission source), and the data content (e.g., position data Xa of the distribution apparatus 3a (distribution source), terminal identification data A of the communication terminal (transmission source of the position data Xa)) that are sequentially arranged.

Then, the transmission/reception unit 31 of the wireless communication unit 30 of the distribution apparatus 3b transmits data having a data structure generated in Step S61 to the gateway 7 (Step S62). Thereby, the transmission/reception unit 71 of the wireless communication control unit 70 of the gateway 7 receives the data transmitted from the distribution apparatus 3b.

Then, the communication unit 77 of the wireless communication control unit 70 transfers the data received in Step S62 to the communication unit 87 of the gateway 7 (Step S63). Thereby, the wired communication control unit 80 receives the data transferred from the wired communication control unit 70.

Then, the conversion unit 82 of the wired communication control unit 80 performs controls for converting a communication method complying with the IEEE802.15.4 standard to a communication method complying with the IEEE802.3 standard, so that Ethernet packet communication can be performed with the data transmitted from the distribution apparatus 3b. Then, the transmission/reception unit 81 of the wired communication control unit 80 generates data to be transmitted to the position data management system 9 (Step S65). The transmission/reception unit 81 generates a data structure in a similar manner as the Step S61. In this example, the data structure of the data generated by the transmission/reception unit 81 includes the system identification data E of the position data management system 9 (transmission destination), the apparatus identification data D of the gateway 7 (transmission source), and the data content (e.g., position data Xa of the distribution apparatus 3a (distribution source), terminal identification data A of the communication terminal 5 (transmission source of the position data Xa)) that are sequentially arranged.

Then, the transmission/reception unit 81 of the wired communication control unit 80 of the gateway 7 transmits the data generated in Step S65 to the position data management system 9 (Step S66). Thereby, the transmission/reception unit 91 of the position data management system 9 receives the data transmitted from the gateway 7.

Then, the storage/readout unit 98 of the position data management system 9 performs a process of managing position data by associating data indicating the time/date of receiving data (e.g., time/date of receiving position data X) and the position data X with respect to the terminal identification data A already stored in the storage unit 99 and storing the associated data as the management data F (see FIG. 13) in the HD 904 (Step S67).

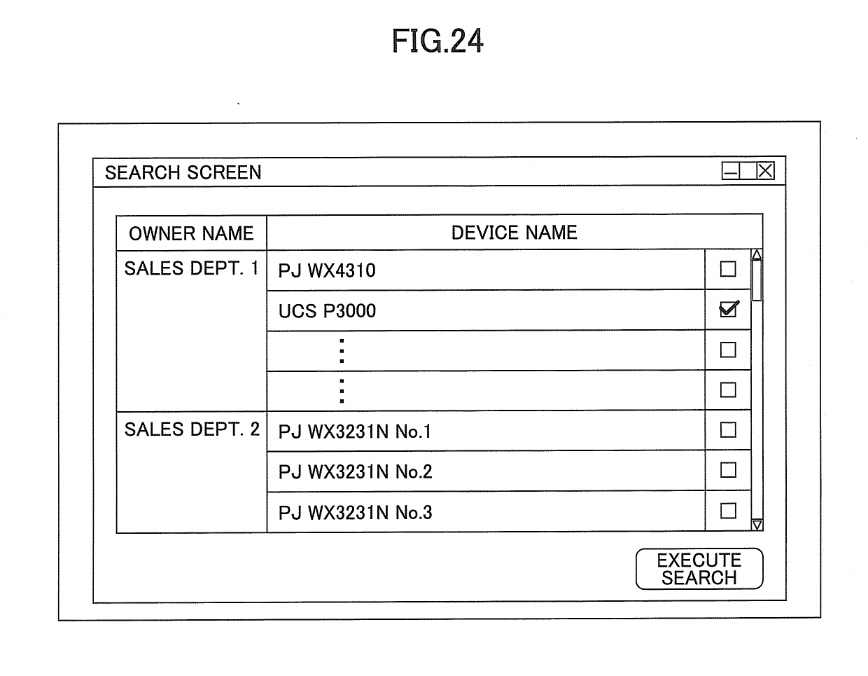

By managing the management data F with the position data management system 9, the administrator of the position data management system 9 can perform a search as illustrated in FIGS. 24 and 25. FIGS. 24 and 25 are schematic diagrams illustrating examples of the screens displayed with the position data management system 9 according to an embodiment of the present invention.

For example, by having the administrator operate, for example, the keyboard 911 or the mouse 912 illustrated in FIG. 12, the operation input reception unit 92 receives an operation input, and the display control unit 94 reads out the management data F by way of the storage/readout unit 98 and displays a search screen (as illustrated in FIG. 24) on the display 908. For example, the search screen displays a search list indicating device names corresponding to each owner name (or administrator name). Further, a checkbox is displayed on the right side of the device name. Further, a button “execute search” is displayed on the lower right side of the search list for executing a search. The example of FIG. 24 illustrates a case of searching the position of the device “UCS P3000” owned by the owner belonging to “sales department 1”.

In a case where the administrator operates, for example, the keyboard 911 or the mouse 912 and checks (marks) the checkbox corresponding to the device name of the device (management object 4) whose position is desired to be searched, the operation input reception unit 92 receives the input of checking the checkbox. Then, after the administrator checks all of the checkbox(es) corresponding to the devices whose positions are desired to be searched, the operation input reception unit 92 receives input of search execution when the administrator presses the button “execute search”. Then, the search unit 93 searches the management data F stored in the storage unit 99 based on the device name corresponding to the checked check box. Thereby, the search unit 93 extracts a part of the management data F including a corresponding position data X and layout data G indicating, for example, the floor of the position indicated by the position data X.

Then, as illustrated in FIG. 25, the display control unit 94 displays a search result screen on the display 908 based on the management data F and the layout data G. For example, a layout diagram indicating the floor “Building A, 4^{th} floor” of the device “ICS P3000” and data items of the management data F (e.g., position data X, reception date/time) are displayed in the search result screen of FIG. 25. Thereby, the administrator of the position data management system 9 can visually recognize the position of the management object 4 (communication terminal 5).

In the above-described embodiment of the present invention, the distribution apparatus 3 not only includes the distribution unit 21 but also the transmission/reception unit 31. Thus, as long as the communication terminal 5 is positioned within a range in which position data X can be distributed from the distribution apparatus 3 (distributable range of the distribution apparatus 3), the communication terminal 5 need only to transmit the position data X and the terminal identification data A within the distributable range of the distribution apparatus 3. Therefore, the communication terminal 5 can transmit data with a minimal amount of power (minimal power consumption). Accordingly, the distribution apparatus 3 contributes to power saving of the communication terminal 5.

Further, because the process of receiving position data is started only in a case where movement of the communication terminal 5 is stopped (after the movement of the communication terminal 5), the power consumption of the battery can be reduced to a small capacity. Thereby, power can be saved. Further, because operations of the components constituting the wireless communication control unit 50 is stopped once the transmission/reception unit 51 completes transmitting data such as the position data X to the distribution apparatus 3, power can be saved. Accordingly, owing to the saving of power, the frequency of performing battery change can be reduced even where a small capacity battery such as the button battery 406 is used, to thereby facilitate the workload of the user.

Further, as illustrated in FIG. 21, installation cost of the distribution apparatus 3 can be reduced because the distribution apparatus 3b can be used to receive the position data Xa and the terminal identification data A from the communication terminal 5 instead of the distribution apparatus 3a (corresponding to the above-described Pattern 1). Further, even in a case where the wireless communication control unit 30 malfunctions, position data Xa and the terminal identification data A can be obtained from the communication terminal 5 in the distribution system 6 (corresponding to the above-described Pattern 2). Further, because position data X and terminal identification data A can be transmitted to the distribution apparatus 3 capable of communicating with highest signal strength, the position data X and the terminal identification data A can be more reliably obtained from the communication terminal 5 in the distribution system 6 (corresponding to the above-described Pattern 3).

The position data management system 9 can be configured by a single computer. Alternatively, position data management system 9 may be configured by dividing the position data management system 9 into multiple elements (functions, function components or storage units) and assign one or more computers to the elements.

Further, a recording medium (e.g., CD-ROM) on which programs of the above-described embodiment are recorded or a hard disk in which the programs are stored may be domestically or internationally provided as a program product.

The determination unit 63 serving as a first determination unit may include the determination unit 53 serving as a second determination unit. That is, the first and second determination units are not only provided separately but also may constitute a single unit. Likewise, the measurement unit 64 serving as a first measurement unit may include the measurement unit 67 serving as a second measurement unit. That is, the first and second measurement units are not only provided separately but also may constitute a single unit.

### (Example of Using Terminal Setting Data)

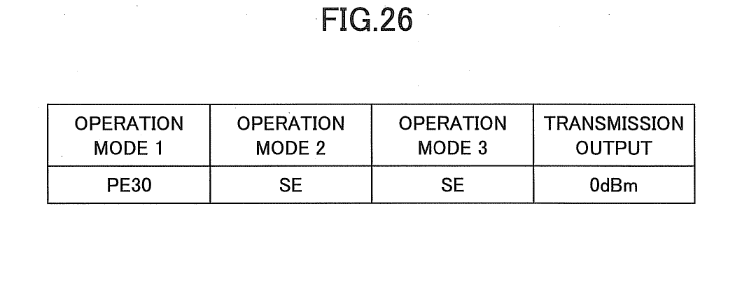

Next, an example where each of the communication terminals performs an inquiry of terminal setting data (data pertaining to settings of a communication terminal) H with respect to the position data management system 9 is described. As illustrated in FIG. 26, the terminal setting data H includes items such as “operation mode 1”, “operation mode 2”, “operation mode 3”, and “transmission output”. FIG. 26 is a schematic diagram illustrating the terminal setting data H stored in the communication terminal 5 according to an embodiment of the present invention. The terminal setting data H may be stored in at least one of the storage unit 49, 59 of the communication terminal 5, and the storage unit 69 of the management object 5g.

The operation mode 1 indicates the timing in which the communication device 5 receives the position data X transmitted from the distribution apparatus 3 (i.e. timing in which the reception unit 41 starts operating). An item “PE” (indicating a predetermined period of operation”) or an item “RT” (indicating a predetermined time of operation) may be set to the item “operation mode 1”. For example, in a case where “PE” is set, a predetermined period (e.g., seconds) in which the reception unit 41 starts operation may also be set to the item “PE”. The item “PE30” indicated in the “operation mode 1” in FIG. 26 indicates that the reception unit 41 periodically starts operation at intervals of 30 seconds. Although not illustrated in FIG. 26, in a case where “RT” is set to the “operation mode 1”, a predetermined time (e.g., hour/minutes) in which the reception unit 41 starts operation may also be set to the item “RT”. For example, an item “RT1230” may be set to “operation mode 1” for indicating that the reception unit 41 starts operation at the time of 12:30. The method for designating the period or time of item “PE” or “RT” is arbitrary. Further, the name of the items “PE” and “RT” (and also the below-described “SE”) may be defined depending on, for example, the purpose of use and an arbitrary name may be assigned to the items of “operation mode 1”.

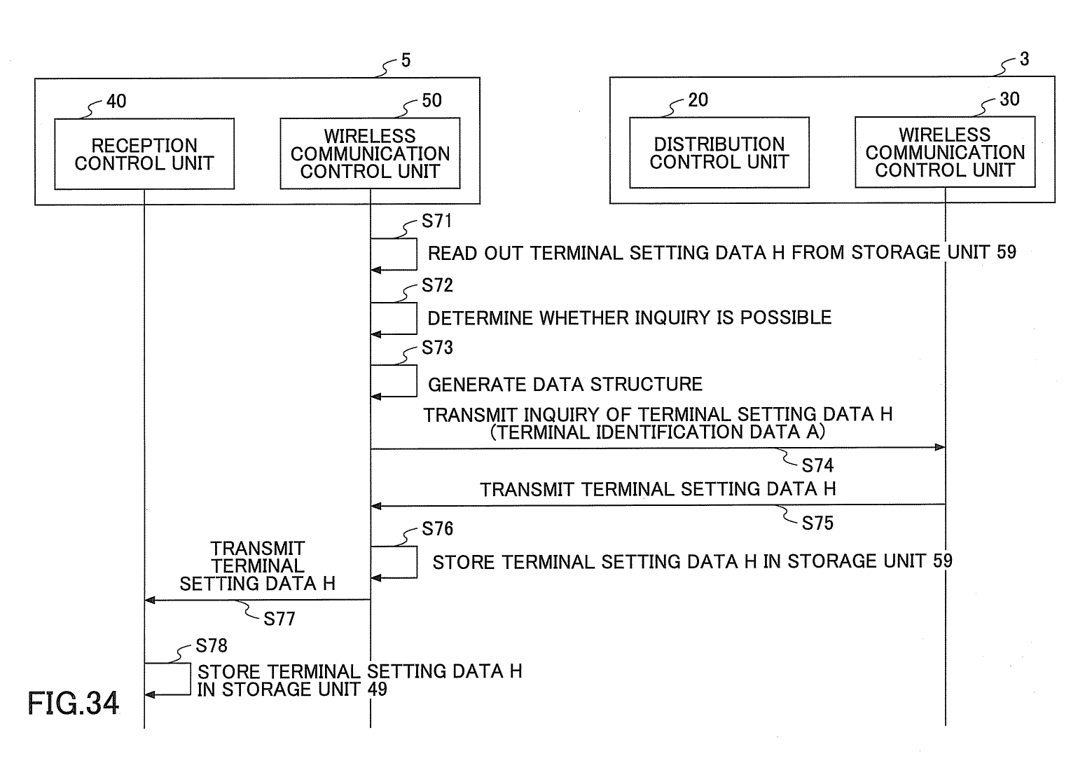

The operation mode 2 indicates the timing in which the communication device 5 transmits the terminal identification data A and the position data X to the distribution apparatus 3 (i.e. timing in which the start command is transmitted in Step S42 of FIG. 34). Similar to “operation mode 1”, items “PE” or “RT” may be set to the item “operation mode 2”. In addition, an item “SE” (indicating that the communication device 5 is to transmit the terminal identification data A and the position data X immediately after the reception unit 41 receives the position data X from the distribution apparatus 3). In other words, in a case where “SE” is set to the item “operation mode 2”, the process of Step S42 is executed immediately after the process of Step S41 as illustrated in the sequence diagram of FIG. 19.

The operation mode 3 indicates the timing in which the communication device 5 transmits an inquiry of terminal setting data H bound for the position data management system 9 to the distribution apparatus 3. Items “PE”, “RT”, or “SE” may be set to the item “operation mode 3”. Upon receiving a response to the inquiry from the position data management system 9, the communication terminal 5 updates the terminal setting data H by using the terminal setting data H received from the position data management system 9.

The item “transmission output” indicates the strength of the electric wave (radio wave) output in the wireless communication by the communication circuit 504 of the communication terminal 5. In FIG. 26, the item “transmission output” is indicated with in units of “dBm”. However, other units that can be applied to the communication circuit 504 of the communication terminal 5 may also be used. The wireless communication unit 15 of the communication terminal 5 controls the strength of electric waves, so that the communication circuit 504 transmits wireless signals based on the settings of the item “transmission output” by way of the antenna 504a. Similarly, in a case where the communication terminal 5 is the management object 6, the strength of electric waves is controlled, so that the communication unit 613 transmits wireless signals based on the settings of the item “transmission output” by way of the antenna 613a.

The items “operation mode 1” to “operation mode 3” may be set separately.

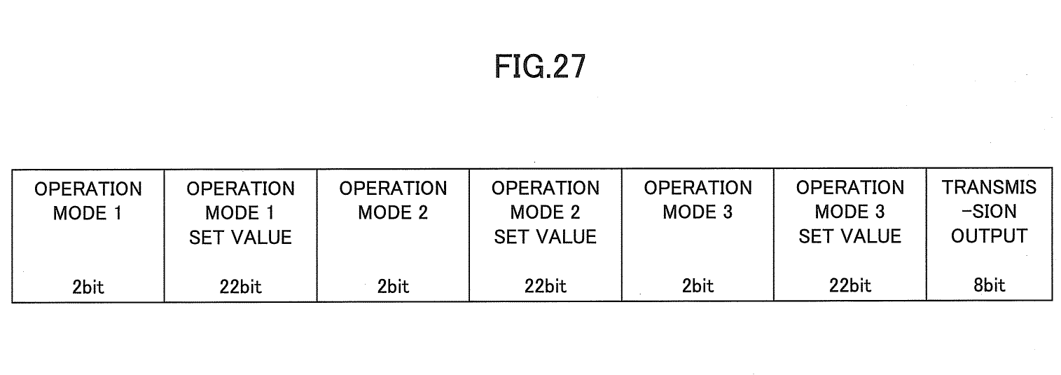

FIG. 27 is a schematic diagram illustrating a communication data format of the terminal setting data H that is transmitted from the position data management system 9 after an inquiry is transmitted from the communication terminal 5 to the position data management system 9 via the distribution apparatus 3 according to an embodiment of the present invention. Given bits strings indicating “PE”, “RT” or “SE” (only “PE” or “RT” for item “operation mode” are stored in the items “operation mode 1” to “operation mode 3”. Further, in a case where “PE” or “RT” is set to the operation modes, setting values indicating a predetermined period or a predetermined time may also be stored. Further, a setting value indicated in a predetermined unit may be stored in the item “transmission output”. The number of bits of the stored data may be arbitrarily set.

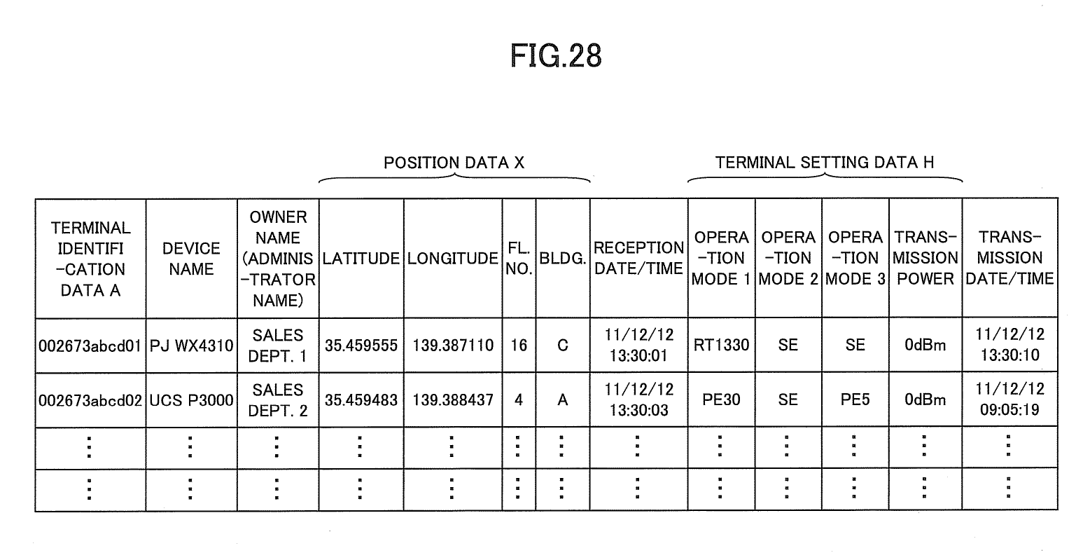

FIG. 28 is a schematic diagram illustrating management data F (including terminal setting data H) stored in the storage unit 99 of the position data management system 9 according to an embodiment of the present invention. The management data F of FIG. 28 is configured having the terminal setting data H of each communication terminal 5 added to the management data illustrated in FIG. 13. Accordingly, the position data management system 9 manages the terminal setting data H of each communication terminal 5 by using the terminal identification data A as a key. The management data F of FIG. 28 may also include “transmission date/time” indicating the date and time of transmitting the terminal setting data H to the communication terminal 5. Accordingly, when the position data management system 9 receives an inquiry of terminal setting data H from the communication terminal 5, the position data management system 9 transmits the terminal setting data H of the communication terminal 5 including the management data F to the communication terminal 5.

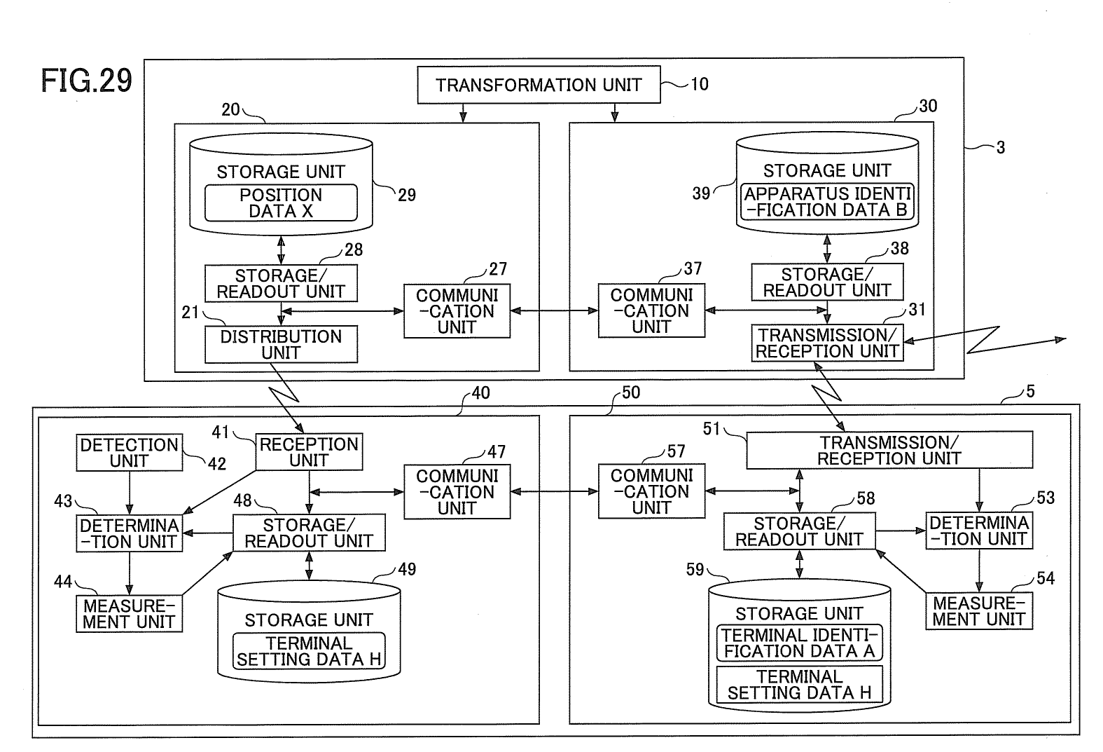

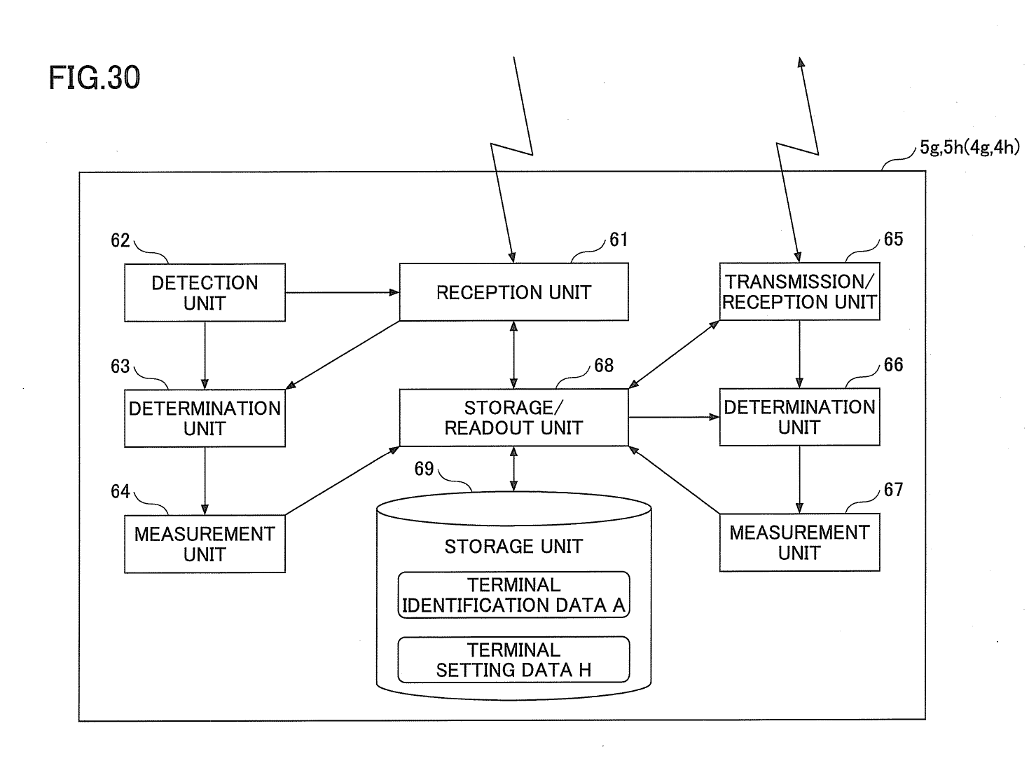

FIGS. 29 and 30 are block diagrams corresponding to the block diagrams of FIGS. 14 and 15 illustrating the distribution apparatus 3 and the communication terminal 5 according to an embodiment of the present invention. In the embodiments illustrated in FIGS. 29 and 30, the terminal setting data H is stored in the storage unit 49 and the storage unit 59 of the communication terminal 5 (or the storage unit 69 of the management object 5g). The same terminal setting data is stored in the storage unit 49 and the storage unit 59. The determination unit 43 and the determination unit 53 (or the determination unit 63 and 66) determines the operation modes and setting values of the terminal setting data H read out by the storage/readout unit 48, 58, or (storage/readout unit 68).

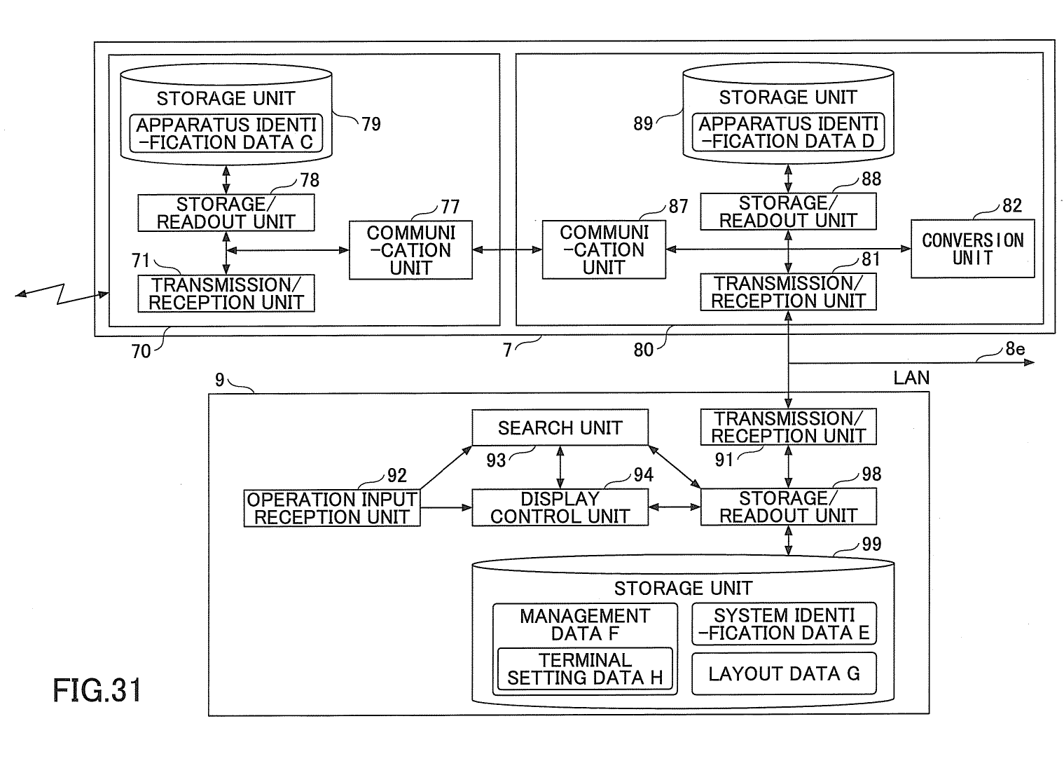

FIG. 31 is a block diagram corresponding to FIG. 15 illustrating the gateway 7 and the position data management system 9 according to an embodiment of the present invention. In the embodiment illustrated in FIG. 31, the terminal setting data H is stored in the management data F stored in the storage unit 99 of the position data management system 9.

Next, further details of the processes using the terminal setting data H (illustrated in FIGS. 26-31) are described with reference to FIG. 19 and FIGS. 32-35.

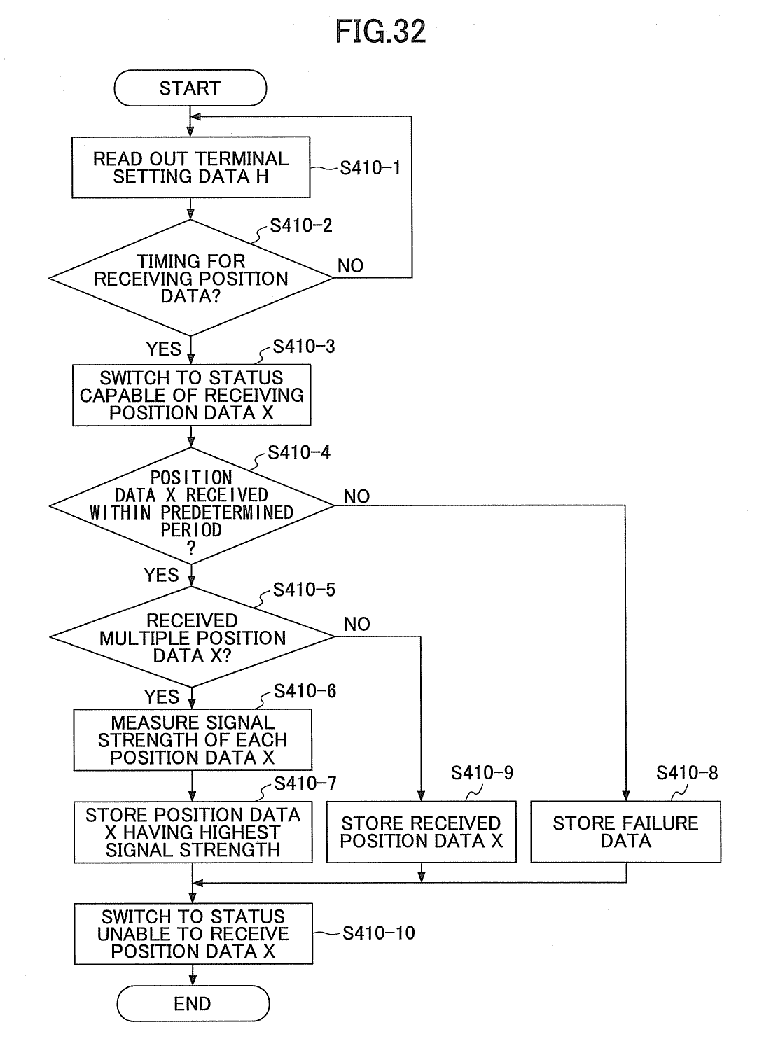

In Step S41 of FIG. 19, the below-described operation illustrated in the flowchart of FIG. 32 may be performed instead of the operation illustrated in the flowchart of FIG. 20. FIG. 32 is a flowchart of an operation of receiving position data based on the settings of operation mode 1 of the terminal setting data H and storing the received position data according to an embodiment of the present invention.

First, the storage/readout unit 48 of the communication terminal 5 reads out the operation mode 1 and its setting values from the terminal setting data H stored in the storage unit 49 (Step S410-1, No in Step S410-2). Then, the determination unit 43 determines whether the timing for receiving position data X is appropriate based on the operation mode 1 and/or its setting values (Step S410-2). The determination unit 43 may refer to the time in which the position data X was received the previous time (previous reception time of position data X). The storage/readout unit 48 may read out the previous reception time of position data X stored in the storage unit 49. In a case where the determination unit 43 determines that the current time is the appropriate timing for receiving the position data X (Yes in Step S410-2), the reception unit 41 switches to a state capable of receiving the position data distributed by the distribution apparatus 3 (Step S410-3). More specifically, in a case where the CPU 401 illustrated in FIG. 7 determines that the current time is the time for receiving the position data X, the CPU 401 transmits a signal to the communication circuit 404 instructing the communication circuit 404 to start operating. Thereby, the communication circuit 404 starts to operate. In a case where the position data Xa, Xb are distributed from the distribution apparatuses 3a, 3b, respectively, the communication circuit 404 of the control unit 14 of the communication terminal 5 can start receiving the position data Xa and Xb by way of the antennal 404a. The subsequent processes performed in Steps S410-4 to S410-10 correspond to the processes performed in Steps S41-6 to S41-12 of FIG. 20.

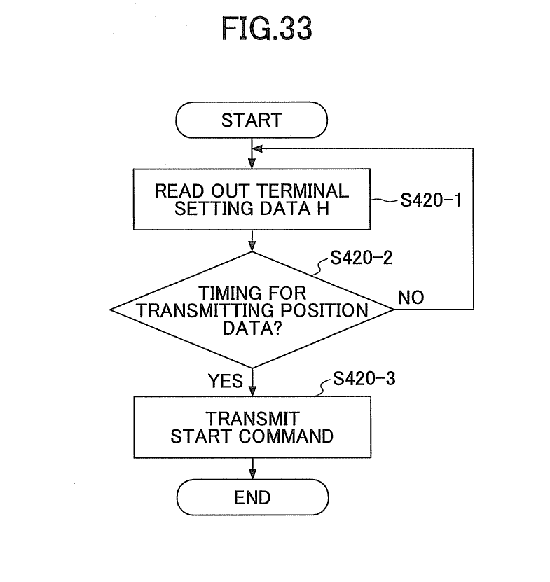

The process performed in Step S42 of FIG. 19 is described in further detail with reference to FIG. 33. FIG. 33 is a flowchart illustrating an operation of the communication unit 47 of the communication terminal 5 instructing the wireless communication control unit 50 to start operating based on the settings of the operation mode 2 of the terminal setting data H according to an embodiment of the present invention.

First, the storage/readout unit 48 of the communication terminal 5 reads out the operation mode 2 and its setting values from the terminal setting data H stored in the storage unit 49 (Step S420-1, No in Step S420-2). Then, the determination unit 43 determines whether the timing for transmitting position data X is appropriate based on the operation mode 2 and/or its setting values (Step S420-2). The determination unit 43 may refer to the time in which the position data X was received the previous time (previous reception time of position data X). The storage/readout unit 48 may read out the previous reception time of position data X stored in the storage unit 49. In a case where the determination unit 43 determines that the current time is the appropriate timing for transmitting the position data X (Yes in Step S420-2), the communication unit 47 transmits a command to the wireless communication control unit 50 instructing the wireless communication unit 50 to start operating (Step S420-3).

Then, returning to FIG. 19, the processes of Step S43 to S50 can be performed. In a case where “SE” is set to “operation mode 2” of the terminal setting data H, the process of Step S42 is performed immediately after process of Step S41.

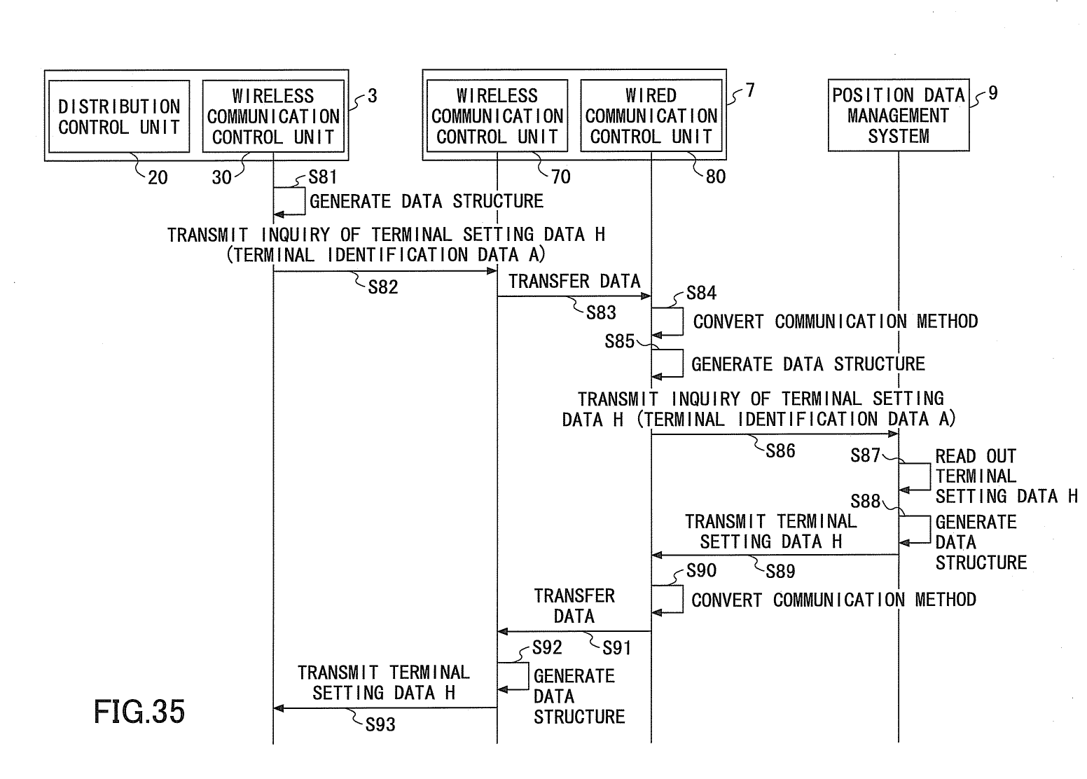

Next, an operation for inquiring a terminal setting data H from the communication terminal 5 to the position data management system 9 and an operation for receiving the terminal setting data H from the position data management system 9 are described with reference to FIGS. 34 and 35. FIG. 34 is a sequence diagram illustrating a process of transmitting an inquiry from the communication terminal 5 to the distribution apparatus 3 and a process of receiving the terminal setting data H from the distribution apparatus 3 according to an embodiment of the present invention. FIG. 35 is a sequence diagram illustrating a process of the distribution apparatus 3 relaying the inquiry from the communication terminal 5 and the terminal setting data H from the position data management system 9 according to an embodiment of the present invention.

First, the flow of the processes illustrated in FIG. 34 is described. The storage/readout unit 58 of the communication terminal 5 reads out the terminal setting data H from the storage unit 59 (Step S71). Then, the determination unit 53 of the communication terminal 5 determines whether inquiry of the terminal setting data H is possible based on the operation mode 3 and/or its setting values (Step S72). The determination unit 53 may refer to the time in which an inquiry of terminal setting data H was transmitted the previous time (previous inquiry time of terminal setting data H). The storage/readout unit 58 may read out the previous inquiry time of terminal setting data H stored in the storage unit 59. In a case where the determination unit 43 determines that the inquiry of the terminal setting data H is possible, the transmission/reception unit 51 generates a data structure (illustrated in FIG. 9) of data to be transmitted to the distribution apparatus 3 (transmission destination) (Step S73). In this example, the data structure generated in Step S73 includes the apparatus identification data B of the distribution apparatus 3b (transmission destination), the terminal identification data A of the communication terminal 5 (transmission source), and the data content (e.g., terminal identification data A of the communication terminal 5, data of a predetermined bit string for indicating that the data is an inquiry of the terminal setting data H from the communication terminal 5 and is shared beforehand between the communication terminal 5 and the position data management system 9) that are sequentially arranged. Then, the transmission/reception unit 51 transmits the data having the data structure generated in Step S73 (e.g., terminal setting data A of the communication terminal 5, and data of a predetermined bit string for indicating that the data is an inquiry of the terminal setting data H from the communication terminal 5) to the distribution apparatus 3 (Step S74). Thereby, the wireless communication control unit 30 of the distribution apparatus 3 receives the inquiry transmitted from the communication terminal 5. Then, after the processes of FIG. 35, the wireless communication control unit 30 of the distribution apparatus 3 receives data including the terminal setting data H from the position data management system 9 and transmits the received terminal setting data H to the communication terminal 5 (Step S75). The storage/readout unit 58 of the communication terminal 5 stores the received data including the terminal setting data H in the storage unit 59 (Step S76). In a case where the terminal setting data H is already stored in the storage unit 59, the terminal setting data H already stored in the storage unit 59 may be updated with the newly received terminal setting data H. Then, the communication unit 57 of the communication terminal 5 transmits the received terminal setting data H to the communication unit 47 of the reception control unit 40 (Step S77). Then, the storage/readout unit 48 stores the received terminal setting data H in the storage unit 49 (Step S78). In a case where the terminal setting data H is already stored in the storage unit 49, the terminal setting data H already stored in the storage unit 49 may be updated with the newly received terminal setting data H.

In a case where the data received by the wireless communication control unit 50 of the communication terminal 5 indicates that there is no corresponding terminal setting data H in the position data management system 9 (described in detail below), the performing of the processes in Step S76 to Step S78 may be omitted.

Next, the flow of the processes illustrated in FIG. 35 is described. First, as illustrated in the process of Step S73 of FIG. 34, the wireless communication control unit 30 of the distribution apparatus 3 generates a data structure of the data to be transmitted to the gateway 7 (Step S81). In this example, the data structure of the data generated in Step S81 includes the apparatus identification data C of the gateway 7 (transmission destination), the apparatus identification data B of the distribution apparatus 3 (transmission source), and the data content (e.g., terminal identification data A of the communication terminal 5, data of a predetermined bit string for indicating that the data is an inquiry of the terminal setting data H from the communication terminal 5) that are sequentially arranged.

Then, the transmission/reception unit 31 of the wireless communication control unit 30 of the distribution apparatus 3 transmit the data having the data structure generated in Step S81 to the gateway 7 (Step S82). Thereby, the transmission/reception unit 71 of the wireless communication control unit 70 of the gateway 7 receives data transmitted from the distribution apparatus 3.

Then, the communication unit 77 of the wireless communication control unit 70 transfers the data received in Step S82 to the communication unit 87 of the gateway 7 (Step S83). Thereby, the wired communication control unit 80 receives the data transferred from the wireless communication control unit 70.

Then, the conversion unit 82 of the wired communication control unit 80 performs controls for converting a communication method complying with the IEEE802.15.4 standard to a communication method complying with the IEEE802.3 standard, so that Ethernet packet communication can be performed with the data transmitted from the distribution apparatus 3b. Then, the transmission/reception unit 81 of the wired communication control unit 80 generates data to be transmitted to the position data management system 9 (Step S85). The transmission/reception unit 81 generates the data in a similar manner as the Step S81. In this example, the data structure of the data generated by the transmission/reception unit 81 includes the system identification data E of the position data management system 9 (transmission destination), the apparatus identification data D of the gateway 7 (transmission source), and the data content (e.g., terminal identification data A of the communication terminal 5, data of a predetermined bit string for indicating that the data is an inquiry of the terminal setting data H from the communication terminal 5) that are sequentially arranged.

Then, the transmission/reception unit 81 of the wired communication control unit 80 of the gateway 7 transmits the data generated in Step S85 to the position data management system 9 (Step S86). Thereby, the transmission/reception unit 91 of the position data management system 9 receives the data transmitted from the gateway 7.

Then, when the position data management system 9 receives the data including the inquiry of the terminal setting data H from the gateway 7, the storage/readout unit 98 reads out the terminal setting data H corresponding to the terminal setting data H included in the received data, from the storage unit 99 (Step S87). Then, the transmission/reception unit 91 of the position data management system 9 generates a data structure of the data to be transmitted to the communication terminal 5 in a manner illustrated in Step S73 of FIG. 34 (Step S88). In this example, the data structure of the data generated by the transmission/reception unit 91 includes the apparatus identification data C of the gateway 7 (transmission destination), the system identification data E of the position data management system 9 (transmission source), and the data content (e.g., terminal identification data A of the communication terminal 5, terminal setting data H of the communication terminal 5 having the data configuration illustrated in FIG. 27) that are sequentially arranged. Then, the transmission/reception unit 91 of the position data management system 9 transmits the data having the data structure generated in Step S88 to the gateway 7 (Step S89). Thereby, the transmission/reception unit 81 of the gateway 7 receives the data transmitted from the position data management system 9. The time in which the data is transmitted to the gateway 7 is stored in the management data F of FIG. 28. In a case where no terminal setting data H corresponding to the terminal identification data A cannot be read out in Step S87 (i.e. no terminal setting data H corresponding to the terminal identification data A stored in the storage unit 99), the transmission/reception unit 91 of the position data management system 9 may include data indicating no corresponding setting data in the data content of the data structure generated in Step S87. For example, the data may have a bit string entirely constituted by 0 in the data structure illustrated in FIG. 27.

Then, the conversion unit 82 of the wired communication control unit 80 of the gateway 7 converts the communication method complying with the IEEE802.3 standard to the communication method complying with the IEEE802.15.4 standard. The data of the converted communication method is transferred to the wireless communication control unit 77 (Step S91). Then, the transmission/reception unit 71 of the wireless communication control unit 70 generates a data structure of the data to be transmitted to the distribution apparatus 3 in a manner illustrated in Step S88 (Step S92). In this case, the data structure includes the apparatus identification data B of the distribution apparatus 3 (transmission destination), the apparatus identification data D (transmission source), and the data content (e.g., terminal identification data A of the communication terminal 5, terminal setting data H of the communication terminal having the data structure illustrated in FIG. 27). The apparatus identification data set as the transmission destination is not limited to the distribution apparatus 3. The data having the data structure generated in Step S92 need only be transmitted to the communication terminal 5 via a communication network formed by the wireless communication control unit 70. Accordingly, the apparatus identification data B of an arbitrary distribution apparatus 3 or the terminal identification data A of the communication terminal 5 may be selected as the transmission destination according to route data of the communication network at the time of executing the process in Step S92.

Then, the transmission/reception unit 71 of the wireless communication control unit 70 of the gateway 7 transmits the data having the data structure generated in Step S92 to the distribution apparatus 3 or another distribution apparatus located on an optimum route to the communication terminal 5 (Step S93). Thereby, the transmission/reception unit 31 of the distribution apparatus 3 can receive the data transmitted from the gateway 7.

With the above-described embodiment, the position data management system 9 can unify (consolidate) the management of the terminal setting data H of each of the communication terminals 5. Further, each communication terminal 5 can periodically transmit an inquiry of the terminal setting data H to the position data management system 9 at a predetermined period, a predetermined time, or at a timing for transmitting position data. For example, the communication terminal 5 can control the communication amount for transmitting an inquiry to a minimal amount by transmitting an inquiry of the terminal setting data of the communication terminal itself at a timing of receiving the position data X. This contributes to power saving of the communication terminal 5.

The present invention is not limited to the specifically disclosed embodiments, and variations and modifications may be made without departing from the scope of the present invention.

The present application is based on Japanese Priority Application Nos. 2012-056958 and 2012-226948 filed on Mar. 14, 2012 and Oct. 12, 2012, respectively, the entire contents of which are hereby incorporated by reference.

What is claimed is:

1. A distribution apparatus comprising:
a distribution unit configured to distribute position data indicating a position of the distribution apparatus;
a reception unit configured to receive data from a communication terminal that received the position data distributed by the distribution unit, the data received from the communication terminal including terminal identification data for identifying the communication terminal and the position data; and
a transmission unit configured to transmit terminal setting data of the communication terminal,
wherein the reception unit is configured to receive the terminal setting data from a position data management system according to an inquiry transmitted from the communication terminal.

2. The distribution apparatus as claimed in claim 1, wherein the terminal setting data includes data indicating a timing in which the communication terminal receives the position data.

3. The distribution apparatus as claimed in claim 1, wherein the terminal setting data includes data indicating a timing in which the communication terminal transmits the terminal identification data and the position data.

4. The distribution apparatus as claimed in claim 1, wherein the terminal setting data includes data indicating a timing in which the communication terminal transmits the inquiry.

5. The distribution apparatus as claimed in claim 1,
wherein the communication terminal is configured to transmit the terminal identification data and the position data by way of wireless communication,
wherein the terminal setting data includes data indicating a transmission power of a radio wave of the wireless communication.

6. The distribution apparatus as claimed in claim 1,
wherein the distribution unit is configured to distribute the position data based on a communication method complying with an IMES (Indoor MEssaging System) standard,
wherein the reception unit is configured to receive the terminal identification data and the position data based on a communication method complying with at least a physical layer of a IEEE802.15.4 standard.

7. A position management system comprising:
the distribution apparatus of claim 1; and
a communication terminal configured to transmit data to the distribution apparatus.

8. The position management system as claimed in claim 7, further comprising:
a position data management system configured to transmit terminal setting data to the distribution apparatus.

9. A distribution method using a distribution apparatus, the distribution method comprising the steps of:
a) reading out position data from a storage unit included in the distribution apparatus;
b) distributing the position data read out in step a);
c) receiving terminal identification data and the position data from a communication terminal receiving the position data;
d) receiving an inquiry from the communication terminal; and
e) transmitting terminal setting data of the communication terminal from a position data management system according to the inquiry from the communication terminal.

10. A computer-readable recording medium on which a program for causing a distribution apparatus to perform a distribution method is recorded, the distribution method comprising the steps of:
a) reading out position data from a storage unit included in the distribution apparatus;
b) distributing the position data read out in step a);
c) receiving terminal identification data and the position data from a communication terminal receiving the position data;
d) receiving an inquiry from the communication terminal; and
e) transmitting terminal setting data of the communication terminal from a position data management system according to the inquiry from the communication terminal.
